(19) United States
(12) Patent Application Publication
(10) Pub. No.: US 2026/0259442 A1
(43) Pub. Date: Sep. 3, 2026

(54) VIEWING ANGLE CONTROL PANEL AND DISPLAY DEVICE

(71) Applicants: Hefei BOE Optoelectronics Technology Co., Ltd., Hefei, Anhui (CN); BOE Technology Group Co., Ltd., Beijing (CN); Beijing BOE Technology Development Co., Ltd., Beijing (CN)

(72) Inventors: Dong WANG, Beijing (CN); Hongmin LI, Beijing (CN); Jie YANG, Beijing (CN); Chuanping ZHU, Beijing (CN); Fengping WANG, Beijing (CN); Zhengyan WAN, Beijing (CN)

(21) Appl. No.: 18/994,635

(22) PCT Filed: Apr. 24, 2024
(86) PCT No.: PCT/CN2024/089469

§ 371 Date: Jan. 15, 2025

(30) Foreign Application Priority Data
May 23, 2023 (CN) 202310604346.1

(51) Int. Cl. G02F 1/13; G02F 1/1362; G02F 1/1368

(52) U.S. Cl. CPC G02F 1/1323; G02F 1/136286; G02F 1/1368

(57) ABSTRACT

A viewing angle control panel (12), comprising: a second hole region (C3) and a dimming region (C1) located on at least one side of the second hole region (C3). In a direction perpendicular to the viewing angle control panel (12), the viewing angle control panel (12) comprises: a third substrate (61), a fourth substrate (62), and a second liquid crystal layer (63) located between the third substrate (61) and the fourth substrate (62). The third substrate (61) comprises: a third base (611), and a plurality of second thin film transistors (610), a plurality of second gate lines (66) and a plurality of second data lines (65) located on the third base (611). The plurality of second gate lines (66) extending along a first direction (X) and the plurality of second data lines (65) extending along a second direction (Y).

### CROSS-REFERENCE TO RELATED APPLICATIONS

The present application is a U.S. National Phase Entry of International Application No. PCT/CN2024/089469 having an international filing date of Apr. 24, 2024, which claims priority to Chinese Patent Application No. 202310604346.1, filed to the CNIPA on May 23, 2023 and entitled “Viewing Angle Control Panel and Display Device”. The entire contents of the above-identified applications are incorporated herein by reference.

### TECHNICAL FIELD

The present disclosure relates to, but is not limited to, the field of display technology, in particular to a viewing angle control panel and a display apparatus.

### BACKGROUND

Liquid Crystal Displays (LCDs) have been increasingly widely used due to their advantages such as low power consumption, miniaturization, and thinness. For example, they have been applied in various fields such as mobile phones, flat panel displays, cars, televisions, and public displays.

### SUMMARY

The following is a summary of subject matters described herein in detail. This summary is not intended to limit the protection scope of claims.

An embodiment of the present disclosure provides a viewing angle control panel and a display apparatus.

In one aspect, the present embodiment provides a viewing angle control panel including: a second hole region and a dimming region located on at least one side of the second hole region. In a direction perpendicular to the viewing angle control panel, the viewing angle control panel includes: a third base substrate, a fourth base substrate, and a second liquid crystal layer disposed between the third base substrate and the fourth base substrate. The third base substrate includes a third substrate, and a plurality of second thin film transistors located on the third substrate, a plurality of second gate lines extending along a first direction, and a plurality of second data lines extending along a second direction; the first direction intersects the second direction. Two adjacent second gate lines and two adjacent second data lines define a sub-dimming region, and at least one sub-dimming region is provided with a second thin film transistor; the second thin film transistor is configured to control deflection directions of liquid crystal molecules of the second liquid crystal layer located in a corresponding sub-dimming region, so that light incident into the sub-dimming region is emitted in a transmission state or scattering state.

In some exemplary embodiments, the second hole region of the viewing angle control panel includes: a second light transmitting region and a second light shielding region surrounding the second light transmitting region. The fourth base substrate includes: a fourth substrate and a second black matrix disposed on the fourth substrate. The second black matrix has a first edge and a second edge in the second light shielding region; the second light shielding region has an inner edge and an outer edge; the first edge of the second black matrix is flush with the inner edge of the second light shielding region; the second edge of the second black matrix is flush with the outer edge of the second light shielding region, or the second edge of the second black matrix is located on a side of the outer edge of the second light shielding region close to the inner edge.

In some exemplary embodiments, the second black matrix includes: a plurality of first shielding portions located in the dimming region extending in the first direction; orthographic projections of the first shielding portions on the third substrate cover orthographic projections of the second gate lines and the second thin film transistors on the third substrate.

In some exemplary embodiments, the second edge of the second black matrix in the second light shielding region has first edge portions extending along the first direction and second edge portions extending along the second direction, a shape of a first edge portion matches a shape of a second gate line extending along the first direction, and the first edge portion is connected with a first shielding portion of the dimming region. A second edge portion has a shape of a straight line or a broken line extending along the second direction, and the second edge portion connects adjacent first edge portions.

In some exemplary embodiments, the third base substrate further includes: a plurality of second gate connection lines and a plurality of second data connection lines, the plurality of second gate connection lines and the plurality of second data connection lines are disposed on the third substrate and located in the second light shielding region; the second gate connection lines are configured to connect second gate lines separated by the second hole region, and the second data connection lines are configured to connect second data lines separated by the second hole region.

In some exemplary embodiments, at least one of the second data connection lines includes a fourth arc line segment, the fourth arc line segment is located on a side of the plurality of second gate connection lines close to the second light transmitting region.

In some exemplary embodiments, an orthographic projection of the second black matrix on the third substrate at least partially covers orthographic projections of the plurality of second gate lines, the plurality of second gate connection lines, and the plurality of second data connection lines on the third substrate.

In some exemplary embodiments, at least one second gate connection line of the plurality of second gate connection lines has a first wiring segment and a first turning line segment, and the first wiring segment being electrically connected with a second gate line through the first turning line segment. The first turning line segment has a first bump, and the first bump is located on a side of the first wiring segment away from the second light transmitting region.

In another aspect, the present embodiment provides a display apparatus including: a display panel, and the viewing angle control panel as described above; wherein the display panel includes a first hole region and a display region located on at least one side of the first hole region. The viewing angle control panel is configured to adjust a light emission state of the dimming region according to a display mode of the display panel. The second hole region of the viewing angle control panel is disposed in alignment with the first hole region of the display panel.

In some exemplary embodiments, center positions of the second hole region and the first hole region coincide.

In some exemplary embodiments, the display apparatus further includes: a backlight module, wherein the viewing angle control panel and the display panel are located on a light emission side of the backlight module, and the display panel is located on a side of the viewing angle control panel away from the backlight module. The backlight module includes an camera hole; wherein the camera hole, the first hole region of the display panel and the second hole region of the viewing angle control panel are disposed in alignment.

In some exemplary embodiments, center positions of the camera hole, the first hole region, and the second hole region coincide.

In some exemplary embodiments, the display apparatus further includes a camera assembly located on a side of the backlight module away from the display panel, and the camera assembly includes a camera, wherein at least a part of the camera is located in a camera hole of the backlight module, a center position of the camera coincides with a center position of the camera hole, and a size of the camera in the first direction is smaller than an aperture of the camera hole.

In some exemplary embodiments, the second hole region of the viewing angle control panel includes: a second light transmitting region and a second light shielding region surrounding the second light transmitting region. The first hole region of the display panel includes: a first light transmitting region and a first light shielding region surrounding the first light transmitting region. An orthographic projection of the second light shielding region on the display panel is located within the first light shielding region. An orthographic projection of the first light transmitting region on the viewing angle control panel is located within the second light transmitting region.

In some exemplary embodiments, the first light shielding region has a first outer diameter and a first inner diameter, the first outer diameter is greater than the first inner diameter. the second light shielding region has a second outer diameter and a second inner diameter, the second outer diameter is greater than the second inner diameter. The first outer diameter is greater than the second outer diameter, and the first inner diameter is smaller than the second inner diameter.

In some exemplary embodiments, the first inner diameter is greater than the aperture of the camera hole.

In some exemplary embodiments, the display panel includes: a first base substrate, a second base substrate, and a first liquid crystal layer disposed between the first base substrate and the second base substrate. The first base substrate includes: a first substrate, a plurality of first control circuits, a plurality of first gate lines, a plurality of first data lines, a plurality of first gate connection lines and a plurality of first data connection lines. The plurality of first control circuits, the plurality of first gate lines, and the plurality of first data lines are disposed on the first substrate and located in the display region. The plurality of first gate connection lines and a plurality of first data connection lines are disposed on the first substrate and located in the first light shielding region. The plurality of first control circuits are electrically connected with the plurality of first gate lines and the plurality of first data lines. The first gate connection lines are configured to connect first gate lines separated by the first hole region, and the first data connection lines are configured to connect first data lines separated by the first hole region.

In some exemplary embodiments, at least one first data connection line of the plurality of first data connection lines includes: a second arc line segment. The second arc line segment is located on a side of the plurality of first connection lines close to the first light transmitting region.

In some exemplary embodiments, the plurality of first data connection lines are alternately arranged in a first conductive layer and a second conductive layer, the second conductive layer is located on a side of the first conductive layer away from the first substrate; the plurality of first gate connection lines are located in the first conductive layer.

In some exemplary embodiments, the second base substrate includes: a second substrate, a first black matrix and a plurality of filter units. The first black matrix and the plurality of filter units are disposed on the second substrate. The first black matrix has a plurality of first openings, and the plurality of filter units are respectively located in the plurality of first openings. In a boundary region between the display region and the first light shielding region, sizes of first openings close to the display region are greater than sizes of first openings close to the first light shielding region.

In some exemplary embodiments, an orthographic projection of the first black matrix on the first substrate covers orthographic projections of the plurality of first gate connection lines and the plurality of first data connection lines on the substrate.

Other aspects of the present disclosure may be comprehended after the drawings and the detailed descriptions are read and understood.

### BRIEF DESCRIPTION OF DRAWINGS

Drawings are used to provide understanding of technical solutions of the present disclosure, and form a part of the specification. The drawings and embodiments of the present disclosure are adopted to explain the technical solutions of the present disclosure, and do not form limitations on the technical solutions of the present disclosure.

FIG. 1 is a schematic diagram of a planar structure of a display apparatus according to at least one embodiment of the present disclosure;

FIGS. 2A and 2B are schematic cross-sectional diagrams taken along a direction P-P′ in FIG. 1;

FIG. 2C is another schematic cross-sectional diagram taken along the direction P-P′ in FIG. 1;

FIG. 3 is a planar schematic diagram of a display panel according to at least one embodiment of the present disclosure;

FIG. 4 is a planar schematic diagram of a viewing angle control panel according to at least one embodiment of the present disclosure;

FIG. 5 is a schematic diagram of a structure of a display region of the display panel according to at least one embodiment of the present disclosure;

FIG. 6 is a schematic partial cross-sectional diagram of the display region of the display panel according to at least one embodiment of the present disclosure;

FIG. 7 is a planar schematic diagram of a first hole region of the display panel according to at least one embodiment of the present disclosure;

FIG. 8 is a schematic diagram of wiring in the first hole region of the display panel according to at least one embodiment of the present disclosure;

FIG. 9A is a schematic partial enlarged diagram of a region S1 in FIG. 7;

FIG. 9B is a schematic partial enlarged diagram of a region S2 in FIG. 7;

FIG. 9C is a schematic partial diagram of wiring located in a first conductive layer of FIG. 9A;

FIG. 9D is a schematic partial diagram of wiring located in a second conductive layer of FIG. 9A;

FIG. 10 is a schematic partial enlarged diagram of a region S4 in FIG. 9A;

FIG. 11A is a schematic partial enlarged diagram of a region S5 in FIG. 9A;

FIG. 11B is a schematic cross-sectional diagram taken along a direction Q-Q′ in FIG. 11;

FIG. 12A is a schematic partial enlarged diagram of a region S3 in FIG. 7;

FIG. 12B is a schematic partial enlarged diagram of a region S4 in FIG. 7;

FIG. 13A is a schematic diagram of a first conductive layer of FIG. 12A;

FIG. 13B is a schematic diagram of a second conductive layer of FIG. 12A;

FIGS. 14A and 14B are planar schematic partial diagrams of a first black matrix according to at least one embodiment of the present disclosure;

FIG. 15 is a schematic diagram of a structure of a dimming region of the viewing angle control panel according to at least one embodiment of the present disclosure;

FIG. 16A is a schematic partial cross-sectional diagram of the dimming region of the viewing angle control panel according to at least one embodiment of the present disclosure;

FIG. 16B is a planar schematic partial diagram of the dimming region of the viewing angle control panel according to at least one embodiment of the present disclosure;

FIG. 17 is a planar schematic diagram of a second hole region of the viewing angle control panel according to at least one embodiment of the present disclosure;

FIG. 18 is a schematic diagram of wiring in the second hole region of the viewing angle control panel according to at least one embodiment of the present disclosure;

FIG. 19A is a schematic partial enlarged diagram of a region S6 in FIG. 17;

FIG. 19B is a schematic partial enlarged diagram of a region S7 in FIG. 17;

FIG. 19C is a schematic partial enlarged diagram of a region S8 in FIG. 17;

FIG. 19D is a schematic partial enlarged diagram of a region S9 in FIG. 17;

FIG. 20 is a planar schematic partial diagram of a second black matrix according to at least one embodiment of the present disclosure;

FIG. 21 is another planar schematic partial diagram of a second black matrix according to at least one embodiment of the present disclosure.

### DETAILED DESCRIPTION

The embodiments of the present disclosure will be described below with reference to the drawings in detail. Implementations may be implemented in multiple different forms. Those of ordinary skills in the art can easily understand such a fact that implementations and contents may be transformed into other forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

In the drawings, a size of one or more constituent elements, a thickness of a layer, or a region is sometimes exaggerated for clarity. Therefore, one implementation of the present disclosure is not necessarily limited to the size, and a shape and a size of one or more components in the drawings do not reflect an actual scale. In addition, the drawings schematically illustrate ideal examples, and an implementation of the present disclosure is not limited to shapes, numerical values, or the like shown in the drawings.

Ordinal numerals “first”, “second”, “third”, etc., in the specification are set not to form limitations in numbers but only to avoid confusion between constituent elements. In the present disclosure, “plurality” represents two or more than two.

In the specification, for convenience, expressions “middle portion”, “above”, “below”, “front”, “back”, “vertical”, “horizontal”, “top”, “bottom”, “inside”, “outside”, etc., for indicating directional or positional relationships are used to illustrate positional relationships between the constituent elements with reference to the drawings, not to indicate or imply that involved apparatuses or elements are required to have specific orientations or are structured and operated in the specific orientations but only to easily describe the present specification and simplify the description, and thus should not be understood as limitations on the present disclosure. The positional relationships between the constituent elements are changed as appropriate according to directions of the constituent elements described. Therefore, appropriate replacements based on situations are allowed, which is not limited to the expressions in the specification.

In the specification, unless otherwise explicitly specified and defined, terms “mounting”, “coupling”, and “connection” should be understood in a broad sense. For example, it may be a fixed connection, a detachable connection, or an integral connection; it may be a mechanical connection or a connection; it may be a direct connection, an indirect connection through a middleware, or an internal communication inside two elements. Those of ordinary skills in the art can understand meanings of the aforementioned terms in the present disclosure according to situations.

In the specification, an “electrical connection” includes a case that constituent elements are connected together through an element with a certain electrical action. The “element with a certain electrical effect” is not particularly limited as long as electrical signals between the connected constituent elements may be transmitted. Examples of the “element with a certain electrical effect” not only include an electrode and a wiring, but also include a switching element such as a transistor, a resistor, an inductor, a capacitor, and other elements with a plurality of functions, etc.

In the specification, a transistor refers to an element which at least includes three terminals, i.e., a gate electrode, a drain electrode, and a source electrode. The transistor has a channel region between the drain electrode (e.g. drain electrode terminal, drain electrode region, or drain electrode) and the source electrode (e.g. source electrode terminal, source electrode region, or source electrode), and a current can flow through the drain electrode, the channel region, and the source electrode. In the specification, the channel region refers to a region through which a current mainly flows.

In the specification, a first electrode may be a drain and a second electrode may be a source, or, a first electrode may be a source and a second electrode may be a drain. In a case that transistors with opposite polarities are used, or in a case that a direction of a current is changed during operation of a circuit, or the like, functions of the “source electrode” and the “drain electrode” are sometimes interchangeable. Therefore, the “source electrode” and the “drain electrode” are interchangeable in the specification. In addition, the gate electrode may also be referred to as a control electrode.

In the specification, “parallel” refers to a state in which an angle formed by two straight lines is above −10° and below 10°, and thus also include a state in which the angle is above −5° and below 5°. In addition, “perpendicular” refers to a state in which an angle formed by two straight lines is above 80° and below 100°, and thus also include a state in which the angle is above 85° and below 95°.

In the specification, a circle, oval, triangle, rectangle, trapezoid, pentagon or hexagon, etc. is not strictly speaking, but may be an approximate circle, approximate oval, approximate triangle, approximate rectangle, approximate trapezoid, approximate pentagon or approximate hexagon, etc. Some small deformations due to tolerances may exist, for example, chamfers, curved edges and deformations thereof may exist.

In the present disclosure, “about” and “substantially” refer to a case in which a boundary is not defined strictly and process and measurement errors are allowed to be within a range. In the present disclosure, “substantially the same” refers to a case in which numerical values differ by less than 10%.

In the present disclosure, “A extends along a B direction” means that A may include a main body portion and a secondary portion connected to the main body portion. The main body portion is a line, a line segment, or a strip-shaped body, the main body portion extends along the B direction, and a length of the main body portion extending along the B direction is greater than a length of the secondary portion extending along another direction. “A extends along the B direction” in the present disclosure always means “the main body portion of A extends along the B direction”.

In the present disclosure, “an orthographic projection of B being within a range of an orthographic projection of A” or “an orthographic projection of A containing an orthographic projection of B” means that a boundary of the orthographic projection of B falls within a range of a boundary of the orthographic projection of A, or the boundary of the orthographic projection of A is overlapped with the boundary of the orthographic projection of B. The “shape of A” as used in the present disclosure refers to a shape of the orthographic projection of A on the substrate.

As the technology of liquid crystal displays gradually matures, more and more new products, such as anti-peeping products, emerge. The inventors have found that some display products need to be compatible with an under-screen camera function on the basis of meeting a anti-peeping requirement to meet the actual usage needs of users. For example, as the demand for in-vehicle display increases, an in-vehicle display apparatus may include an in-vehicle central control screen, a main driver screen, and a co-pilot screen to meet different usage needs of the screens of a main driver position and a co-pilot position; with the development of technology, a vehicle central control screen, the main driver screen and the co-pilot screen can be designed in an integrated manner. In order to prevent a display of the co-pilot screen from affecting a driving safety of the main driver, the co-pilot screen needs to be implemented with a anti-peeping treatment for the main driver, and the main driver screen has a requirement to integrate an under-screen camera function, so as to realize face recognition, keyless start of the vehicle and other functions at the main driver position.

The present embodiment provides a viewing angle control panel and a display apparatus, which can be compatible with an under-screen camera function on the basis of realizing a anti-peeping function, so as to improve a user experience.

The present embodiment provides a viewing angle control panel, which includes: a second hole region and a dimming region on at least one side of the second hole region. In a direction perpendicular to the viewing angle control panel, the viewing angle control panel includes: a third base substrate, a fourth base substrate, and a second liquid crystal layer disposed between the third base substrate and the fourth base substrate. The third base substrate includes: a third substrate, and a plurality of second thin film transistors, a plurality of second gate lines extending along a first direction, and a plurality of second data lines extending along a second direction on the third substrate. Herein, the first direction intersects with the second direction, for example, the first direction is perpendicular to the second direction. Two adjacent second gate lines and two adjacent second data lines define a sub-dimming region, and at least one sub-dimming region is provided with a second thin film transistor. The second thin film transistor is configured to control deflection directions of liquid crystal molecules of the second liquid crystal layer located in a corresponding sub-dimming region so that light incident into the sub-dimming region is emitted in a transmission or scattering state.

In some examples, the light being emitted in a transmission state means that the liquid crystal molecules of the sub-dimming region do not change a propagation direction of the light; the light being emitted in the scattering state means that the liquid crystal molecules in the sub-dimming region change the propagation direction of the light and the light are emitted in a scattering mode. For example, when the viewing angle control panel operates in the transmission state, it can realize an anti-peeping state, and when the viewing angle control panel operates in the scattering state, it can realize a shared state.

For example, the plurality of second thin film transistors can control the deflection directions of the liquid crystal molecules in corresponding sub-dimming regions, and the plurality of second thin film transistors simultaneously control the deflection directions of the liquid crystal molecules in different sub-dimming regions, so that the viewing angle control panel can have the anti-peeping state and the shared state at a same time.

In some examples, the viewing angle control panel may be an intelligent view control (SVC) box that may be configured to enable the display panel to switch between a non-anti-peeping state (or referred to as the shared state) and the anti-peeping state. The viewing angle control panel of the present example can have the anti-peeping state and the shared state at the same time, thereby realizing a regional anti-peeping function (e.g., making only a partial region of the display panel visible to the user). However, the present embodiment is not limited thereto.

The viewing angle control panel provided in the present embodiment can realize the anti-peeping function; by providing the second hole region in the viewing angle control panel, it is possible to facilitate the display apparatus including the viewing angle control panel to realize the under-screen camera function compatibly, thereby improving the user experience.

In some exemplary embodiments, the second hole region of the viewing angle control panel includes: a second light transmitting region and a second light shielding region surrounding the second light transmitting region. The fourth base substrate includes: a fourth substrate and a second black matrix disposed on the fourth substrate. The second black matrix has a first edge and a second edge in the second light shielding region; the second light shielding region has an inner edge and an outer edge; the first edge of the second black matrix is flush with the inner edge of the second light shielding region; the second edge of the second black matrix is flush with the outer edge of the second light shielding region, or the second edge of the second black matrix is located on a side of the outer edge of the second light shielding region close to the inner edge. A structure of the second black matrix of the present example can ensure a dimming effect of the dimming region.

In some exemplary embodiments, the second black matrix may include: a plurality of first shielding portions located in the dimming region extending along the first direction; orthographic projections of the first shielding portions on the third substrate cover orthographic projections of the second gate lines and the second thin film transistors on the third substrate. An arrangement mode of the second black matrix in the dimming region of the present example is advantageous to maximize openings, thereby improving the dimming effect.

In some exemplary embodiments, the second edge of the second black matrix in the second light shielding region has first edge portions extending along the first direction and second edge portions extending along the second direction. A shape of a first edge portion matches a shape of a second gate line extending along the first direction, and the first edge portion is connected with a first shielding portion of the light dimming region. A second edge portion has a shape of a straight line or a broken line extending in the second direction, and the second edge portion connects adjacent first edge portions. The structure of the second black matrix of the present example not only ensures the dimming effect of the dimming region, but also make an edge shape of the second light shielding region to be substantially the same as a shape of the dimming region, which is beneficial for ensuring consistency in the shape of the openings and uniformity in dimming effect.

In some exemplary embodiments, the third base substrate further includes: a plurality of second gate connection lines and a plurality of second data connection lines. The plurality of second gate connection lines and a plurality of second data connection lines are disposed on the third substrate and located in the second light shielding region. The second gate connection lines are configured to connect the second gate lines separated by the second hole region, and the second data connection lines are configured to connect the second data lines separated by the second hole region. By disposing the second gate connection lines in the second light shielding region, signal transmission in the first direction can be ensured, and by disposing the second data connection lines in the second light shielding region, signal transmission in the second direction can be ensured.

In some exemplary embodiments, at least one second data connection line includes a fourth arc line segment. The fourth arc line segment is located on a side of the plurality of second gate connection lines close to the second light transmitting region. A wiring arrangement of the second light shielding region of the present example is beneficial for saving space.

In some exemplary embodiments, a film layer in which the plurality of second gate connection lines are located may be located on a side of a film layer in which the plurality of second data connection lines are located close to the third substrate. For example, the plurality of second gate connection lines may be in a same layer structure, and the plurality of second data connection lines may be in a same layer structure. The wiring arrangement of the second light shielding region of the present example is simple and easy to implement, and can reduce the punching process required for wiring connections, compared to wiring arrangements of the plurality of second gate connection lines in different film layers and the plurality of second data connection lines in different film layers.

In some exemplary embodiments, the fourth base substrate includes: a fourth substrate and a second black matrix disposed on the fourth substrate. An orthographic projection of the second black matrix on the third substrate at least partially covers orthographic projections of the plurality of second gate lines, the plurality of second gate connection lines, and the plurality of second data connection lines on the third substrate. In this example, by disposing the second black matrix to shield the wiring, it can be avoided to affect the dimming effect.

In some exemplary embodiments, at least one second gate connection line of the plurality of second gate connection lines has a first wiring segment and a first turning line segment, the first wiring segment is electrically connected with a second gate line through the first turning line segment; the first turning line segment has a first bump, and the first bump is located on a side of the first wiring segment away from the second light transmitting region. In this example, by disposing the first turning line segment, it is possible to prevent adjacent wring from being shorted due to electrostatic discharge (ESD), or prevent a second gate connection line itself from being disconnected.

The present embodiment also provides a display apparatus including: a display panel and a viewing angle control panel as described above. The display panel includes a first hole region and a display region located on at least one side of the first hole region. The viewing angle control panel is configured to adjust a light emission state of the dimming region according to a display mode of the display panel. A second hole region of the viewing angle control panel is disposed in alignment with the first hole region of the display panel. In this embodiment, “A being disposed in alignment with B” means that A and B are arranged in one direction with overlapping orthographic projections.

The display apparatus provided in the present embodiment can realize the anti-peeping function by disposing the viewing angle control panel, and by disposing the second hole region of the viewing angle control panel to be in alignment with the first hole region of the display panel, the under-screen camera function can be compatibly realized, thereby improving the user experience.

In some examples, the center positions of the first hole region of the display panel and the second hole region of the viewing angle control panel may coincide. In the present embodiment, the coincidence of the center positions of A and B may include: complete coincidence of the center positions of A and B (for example, orthographic projections of the center positions of A and B on a horizontal plane may coincide), or substantial coincidence of the center positions of A and B with process and assembly errors within an allowable range. For example, the first hole region may be circular or oval in a shape, and a center position of the first hole region may be a center of the circle or oval; as another example, the first hole region may be a rectangle in a shape, and the center position of the first hole region may be a center of the rectangle.

In some examples, shapes of the first hole region and the second hole region may be the same. The present embodiment is not limited thereto. For example, the shapes of the first hole region and the second hole region may be different.

In some exemplary embodiments, the display apparatus may further include: a backlight module; the viewing angle control panel and the display panel are located on a light emission side of the backlight module, and the display panel is located on a side of the viewing angle control panel far away from the backlight module. The backlight module includes a camera hole. The camera hole of the backlight module, the first hole region of the display panel and the second hole region of the viewing angle control panel are disposed in alignment. In some examples, center positions of the camera hole of the backlight module, the first hole region of the display panel, and the second hole region of the viewing angle control panel may coincide. In some examples, shapes of the camera hole, the first hole region, and the second hole region may be substantially the same. For example, the shapes of the camera hole, the first hole region, and the second hole region may all be circular. The present embodiment is not limited thereto.

In the display apparatus provided in the present embodiment, by disposing the viewing angle control panel, the anti-peeping function can be realized. By disposing the camera hole in the backlight module, disposing the first hole region in the display panel, disposing the second hole region in the viewing angle control panel, and disposing the camera hole of the backlight module, the first hole region of the display panel and the second hole region of the viewing angle control panel in alignment, the under-screen camera function can be compatible, thereby improving the user experience.

In some examples, the display apparatus may be a product having an image (including a static image or a dynamic image, where the dynamic image may be a video) display function. For example, the display apparatus may be any one of the following products: a display, a television, a billboard, a digital photo frame, a laser printer with display function, a telephone, a mobile phone, a picture screen, a personal digital assistant (PDA), a digital camera, a portable camcorder, a viewfinder, a navigator, an in-vehicle display screen, a large-area wall, an information inquiry equipment (such as business inquiry equipment in e-government, banks, hospitals, power departments), a monitor, or the like. The present embodiment is not limited thereto.

Solutions of the embodiments will be described below through some examples.

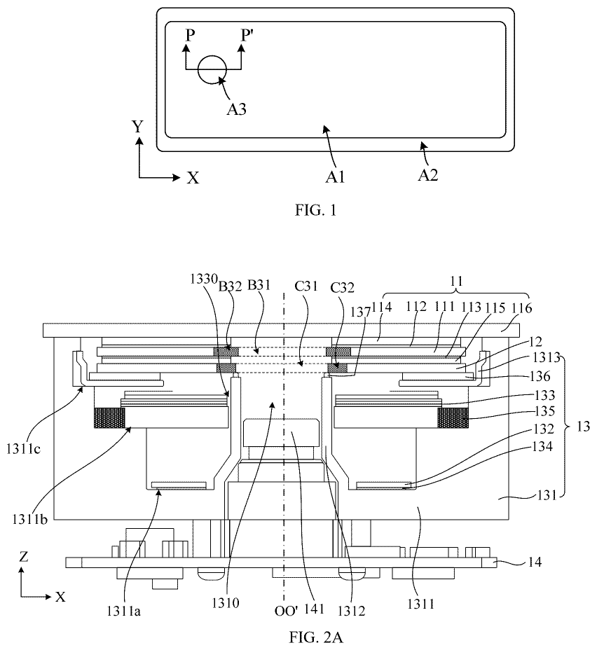

FIG. 1 is a schematic diagram of a planar structure of a display apparatus according to at least one embodiment of the present disclosure. In some examples, as shown in FIG. 1, the display apparatus may include an effective region A1, a first non-display region A2, and a second non-display region A3. The effective region A1 may surround the second non-display region A3, and the first non-display region A2 may surround the effective region A1. For example, the second non-display region A3 may also be referred to as an under-screen camera region, and the first non-display region A2 may also be referred to as an outer bezel region.

In some examples, as shown in FIG. 1, the second non-display region A3 may be located in a center position of a left portion of the display apparatus. However, the present embodiment is not limited thereto. For example, the second non-display region A3 may be located at another position, such as a center position of a right portion, an upper left corner, an upper right corner, a lower left corner, or a lower right corner of the display apparatus. For example, the effective region may surround at least one side of the second non-display region.

In some examples, as shown in FIG. 1, the second non-display region A3 may be circular in a shape. However, the present embodiment is not limited thereto. For example, the second non-display region may be in another shape, such as a rounded rectangle or an oval in shape. The first non-display region A2 may be in a shape of a rectangular ring or a rounded rectangular ring surrounding the effective region A1. The present embodiment is not limited thereto.

In some examples, as shown in FIG. 1, a plane in which the effective region A1 of the display apparatus is located may be parallel to a plane in which the first direction X and the second direction Y are located. Herein, the first direction X intersects with the second direction Y, for example, the first direction X may be perpendicular to the second direction Y. For example, the display apparatus may be an in-vehicle display screen having a regional anti-peeping function. In the first direction X, the effective region A1 may have a first center line, and the first center line may be parallel to the second direction Y. A left effective region on a left side of the first center line may be a main driver display region, and a right effective region on a right side of the first center line may be a co-pilot display region. The main driver may normally see display contents of the main driver display region but may not see display contents of the co-pilot display region.

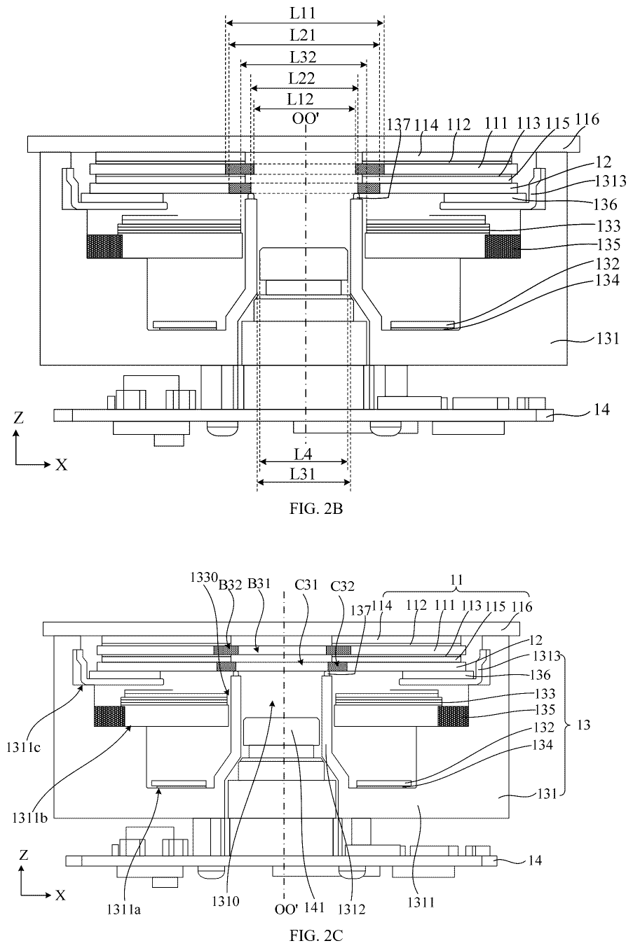

FIGS. 2A and 2B are schematic cross-sectional diagrams taken along a direction P-P′ in FIG. 1. FIG. 2C is another schematic cross-sectional diagram taken along the direction P-P′ in FIG. 1. Herein, a third direction Z may be perpendicular to a plane in which the first direction X and the second direction Y are located. In some examples, as shown in FIGS. 2A and 2B, the display apparatus may at least include a display module 11, a backlight module 13, and a viewing angle control panel 12. The viewing angle control panel 12 and the display module 11 may be located on a light emission side of the backlight module 13, and the display module 11 may be located on a side of the viewing angle control panel 12 away from the backlight module 13. The backlight module 13 may be configured to provide a backlight to the display module 11. In the present example, the light emission side of the backlight module 13 refers to a side from which the backlight module 13 emits light.

In some examples, as shown in FIG. 2A, the backlight module 13 may at least include a back plate 131, a backlight source 132, and a backlight film material 133. Herein, the backlight film material 133 and the backlight source 132 may be disposed on the back plate 131, and the backlight film material 133 may be located on a light emission side of the backlight source 132. The backlight module 13 of the present example may be a straight down backlight module. However, the present embodiment is not limited thereto. In other examples, the backlight module 13 may be a side entry backlight module.

In some examples, as shown in FIG. 2A, the back plate 131 may include a back plate main body 1311 and a bent extension portion 1312. For example, a material of the back plate 131 may be a metal material. The back plate main body 1311 may include a first step portion 1311a, a second step portion 1311b, and a third step portion 1311c which are sequentially connected. The bent extension portion 1312 may be connected with the first step portion 1311a of the back plate main body 1311, and may extend from the first step portion 1311a of the back plate main body 1311 to a side of the back plate 131 close to the display module 11. A length of the bent extension portion 1312 along the third direction Z may be smaller than a length of the back plate main body 1311 along the third direction Z. The bent extension portion 1312 may be connected with an edge of the first step portion 1311a of the back plate main body 1311 away from the second step portion 1311b, and may extend in the third direction Z to form an annular structure. The annular structure of the bent extension portion 1312 may form a first through hole 1310 and surround it.

In some examples, as shown in FIG. 2A, the first through hole 1310 may serve as an camera hole for housing a camera 141 of a camera assembly 14. The camera assembly 14 may be located on a side of the backlight module 13 away from the display module 11. A size of the camera 141 in the first direction X may be smaller than a size of the camera hole (i.e., the first through hole 1310) so that at least a portion of the camera 141 may be located within the camera hole. A center position of the camera 141 may coincide with a center position of the camera hole (i.e., the first through hole 1310). For example, a shape of an orthographic projection of the camera hole may be substantially circular. A shape of a projection of the camera 141 on the plane in which the first direction X and the second direction Y are located may be, for example, a circular. The size of the camera 141 in the first direction X may be a diameter of the shape of the projection of the camera 141. However, the present embodiment is not limited thereto. In other examples, the shape of the orthographic projection of the camera hole may be substantially another shape such as a rounded rectangle, an oval, or a polygon, etc. When the shape of the orthographic projection of the camera hole is circular, the size of the camera hole may include the diameter of the camera hole; when the shape of the orthographic projection of the camera hole is rectangular or polygonal, the size of the camera hole may include a diameter of an inscribed circle of the camera hole. In the present embodiment, the shape of the camera hole is not limited, and it only needs to be able to accommodate at least part of the camera.

In some examples, as shown in FIG. 2A, the backlight source 132 may be located in a first housing space formed by the first step portion 1311a of the back plate main body 1311 and the bent extension portion 1312. For example, the backlight source 132 may include a group of LED lights. The backlight source 132 may be fixed to the first step portion 1311a of the back plate main body 1311 by a first colloid 134. For example, the first colloid 134 may include a thermal conductive glue.

In some examples, as shown in FIG. 2A, the backlight film material 133 may be located in a second housing space formed by the second step portion 1311b of the back plate main body 1311 and the bent extension portion 1312. The second housing space and the first housing space may communicate with each other, and the second housing space may be located on a side of the first housing space away from the first step portion 1311a of the back plate main body 1311. The backlight film material 133 may be fixed to the second step portion 1311b of the back plate main body 1311 by a second colloid 135. For example, the second colloid 135 may include silica gel. In some examples, the backlight film material 133 may include: a light condensing layer, a light uniforming layer, and a light diffusing layer disposed sequentially in a direction close to the backlight source 132. Herein, the light condensing layer may include, for example, a prism configured to perform a light condensing action. The light uniforming layer may include, for example, a diffusion sheet configured to perform a light uniforming action. The light diffusing layer may include, for example, a diffusion plate configured to act as a diffusion of light. The present embodiment is not limited thereto.

In some examples, as shown in FIG. 2A, the backlight film material 133 may have a second through hole 1330 that avoids the bent extension portion 1312. A shape of an orthographic projection of the second through hole 1330 may be substantially circular. The shape of the orthographic projection of the second through hole 1330 may be substantially the same as the shape of the orthographic projection of the first through hole 1310. A size of the second through hole 1330 may be greater than the size of the first through hole 1310, for example, an aperture of the second through hole 1330 may be greater than an aperture of the first through hole 1310. The shape of the second through hole 1330 is not limited in the present embodiment.

In some examples, as shown in FIG. 2A, the back plate 131 may further include a middle iron frame 1313. The middle iron frame 1313 may be connected with the back plate main body 1311, for example, the middle iron frame 1313 may be located on the third step portion 1311c of the back plate main body 1311. The middle iron frame 1313 may be located on a side of the backlight film material 133 away from the backlight source 132. The middle iron frame 1313 may be configured to carry the display module 11 and the viewing angle control panel 12.

In some examples, as shown in FIG. 2A, an edge of the viewing angle control panel 12 may be in contact with the middle iron frame 1313 through a first foam 136. The first foam 136 may be configured to ensure full contact between the viewing angle control panel 12 and the middle iron frame 1313, and may serve as a buffer to protect the viewing angle control panel 12 and the display module 11. The bent extension portion 1312 of the back plate 131 may be in contact with a middle region of the viewing angle control panel 12 through the second foam 137 to play a supporting role for the viewing angle control panel 12 and the display module 11. The second foam 137 may serve as a buffer.

In some examples, as illustrated in FIG. 2A, the display module 11 may include: a display panel 111, a first polarizer 112 and a cover plate 116 which are located on a display side of the display panel 111, and a second polarizer 113 located on a non-display side of the display panel 111. The display side of the display panel 111 in the present example refers to a side on which the display panel 111 displays an image. The cover plate 116 may be located on a side of the first polarizer 112 away from the display panel 111. The cover plate 116 and the first polarizer 112 may be bonded by a first adhesive layer 114, and the second polarizer 113 and the viewing angle control panel 12 may be bonded by a second adhesive layer 115. The first adhesive layer 114 and the second adhesive layer 115 may include, for example, an Optically Clear Adhesive (OCA). In some examples, polarization axes of the first polarizer 112 and the second polarizer 113 may be perpendicular to each other, or may be parallel to each other. The present embodiment is not limited thereto.

In some examples, the display panel 111 may be a High Aperture Advanced Super Dimension Switch (HADS) type liquid crystal cell, or may be an Advanced Super Dimension Switch (ADS) type liquid crystal cell. However, a type of the display panel is not limited in the present embodiment. For example, the display panel may be an In-Plane Switching (IPS) type liquid crystal cell, a Twisted Nematic (TN) type liquid crystal cell, or a Vertical Alignment (VA) type liquid crystal cell.

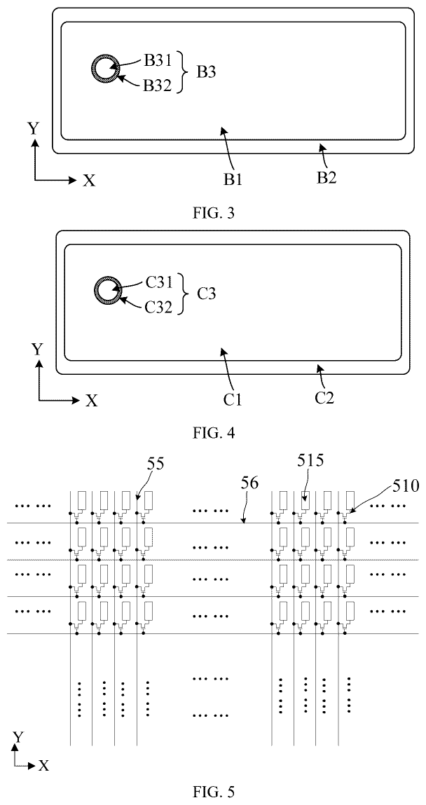

FIG. 3 is a planar schematic diagram of a display panel according to at least one embodiment of the present disclosure. In some examples, as illustrated in FIG. 3, the display panel may include: a display region B1, a first bezel region B2, and a first hole region B3. The first bezel region B2 surrounds the display region B1, and the display region B1 may surround the first hole region B3. The first hole region B3 may also be referred to as a first blind hole, and the first hole region B3 may be a non-display region. The first hole region B3 corresponds to a second non-display region of the display apparatus, and the display region B1 corresponds to the effective region of the display apparatus.

In some examples, as shown in FIG. 3, the first hole region B3 may include a first light transmitting region B31, and a first light shielding region B32 surrounding the first light transmitting region B31. An edge of the first light transmitting region B31 is an inner edge of the first light shielding region B32, and an outer edge of the first light shielding region B32 is connected with the display region B1. Center positions of the first light transmitting region B31 and the first light shielding region B32 may coincide with a center position of the first hole region B3. For example, a shape of an orthographic projection of the first light transmitting region B31 may be a circular, and a shape of an orthographic projection of the first light shielding region B32 may be a circular ring. In this embodiment, the shape of the orthographic projection of the first light transmitting region is not limited, for example, it may be a rounded rectangle or an oval, and the shape of the orthographic projection of the first light shielding region may be a rectangular ring or an oval ring, so as to match the shape of the first light transmitting region.

In some examples, as shown in FIGS. 2A and 2B, a substrate and all film layers within the first light transmitting region B31 may be removed, that is, the first light transmitting region B31 may be a panel through hole. In other examples, as shown in FIG. 2C, the first light transmitting region B31 may include a substrate, such as a glass substrate, or may include a substrate and a film layer which is formed of a light transmitting material. However, the present embodiment is not limited thereto.

In some examples, the viewing angle control panel 12 may be a liquid crystal cell with a switching function for the anti-peeping state and the shared state. In the present embodiment, a type of the liquid crystal cell of the viewing angle control panel is not limited.

FIG. 4 is a planar schematic diagram of a viewing angle control panel according to at least one embodiment of the present disclosure. In some examples, as shown in FIG. 4, the viewing angle control panel may include: a dimming region C1, a second bezel region C2, and a second hole region C3. The second bezel region C2 may surround the dimming region C1, and the dimming region C1 may surround the second hole region C3. The second hole region C3 may also be referred to as a second blind hole, and the second hole region C3 may be a non-dimming region. The second hole region C3 corresponds to the first hole region B3 of the display panel, and the dimming region C1 corresponds to the display region B1 of the display panel.

In some examples, as shown in FIG. 4, the second hole region C3 may include: a second light transmitting region C31 and a second light shielding region C32 surrounding the second light transmitting region C31. An edge of the second light transmitting region C31 is an inner edge of the second light shielding region C32, and an outer edge of the second light shielding region C32 is connected with the dimming region C1. Center positions of the second light transmitting region C31 and the second light shielding region C32 may coincide with a center position of the second hole region C3. For example, a shape of an orthographic projection of the second light transmitting region C31 may be a circular, and a shape of an orthographic projection of the second light shielding region C32 may be a circular ring. In this embodiment, the shape of the orthographic projection of the second light transmitting region is not limited, for example, it may be a rounded rectangle or an oval, and the shape of the orthographic projection of the second light shielding region may be a rectangular ring or an oval ring, so as to match the shape of the second light transmitting region.

In some examples, as shown in FIGS. 2A and 2B, the substrate and all film layers within the second light transmitting region C31 may be removed, that is, the second light transmitting region C31 may be a panel through hole. In other examples, as shown in FIG. 2C, the second light transmitting region C31 may include a substrate (e.g., a glass substrate), or may include a substrate and a film layer which is formed of a light transmitting material. However, the present embodiment is not limited thereto.

In some examples, as shown in FIGS. 2A and 2B, the first hole region (including the first light transmitting region B31 and the first light shielding region B32) of the display panel 111, the second hole region (including the second light transmitting region C31 and the second light shielding region C32) of the viewing angle control panel 12, and the camera hole (i.e., the first through hole 1310) of the backlight module 13 may be disposed in alignment. The center positions of the camera hole, the first hole region, and the second hole region may coincide with each other, that is, the camera hole, the first hole region, and the second hole region may be disposed in a center alignment. For example, the center positions of the camera hole, the first hole region, and the second hole region are all located on a first axis OO′ of the display apparatus. Orthographic projections of the center position of the camera hole, the center position of the first hole region, and the center position of the second hole region on the display panel may coincide.

In some examples, as shown in FIG. 2A, the orthographic projection of the second light shielding region C32 of the viewing angle control panel 12 on the display panel 111 may be located within a range of the orthographic projection of the first light shielding region B32. The orthographic projection of the first light transmitting region B31 of the display panel 111 on the viewing angle control panel 12 may be located within a range of the orthographic projection of the second light transmitting region C31 of the viewing angle control panel 12.

In some examples, as shown in FIGS. 2A and 2B, the first light shielding region B32 of the display panel 111 may have a first outer diameter L11 and a first inner diameter L12. The first outer diameter L11 is greater than the first inner diameter L12. The second light shielding region C32 of the viewing angle control panel 12 may have a second outer diameter L21 and a second inner diameter L22. The second outer diameter L21 is greater than the second inner diameter L22. The first outer diameter L11 may be greater than the second outer diameter L21, and it is ensured that the outer edge of the first light shielding region B32 of the display panel 111 can wrap the outer edge of the second light shielding region C32 of the viewing angle control panel 12, so that the viewing angle control panel 12 can dim the outer edge of the first light shielding region B32 and the regions outside the outer edge of the display panel 111. The first inner diameter L12 may be smaller than the second inner diameter L22, and it is ensured that the inner edge of the first light shielding region B32 of the display panel 111 can wrap the inner edge of the second light shielding region C32 of the viewing angle control panel 12, so that the second light shielding region C32 of the viewing angle control panel 12 does not exceed the first light shielding region B32 of the display panel 111 and does not affect the camera lighting.

In some examples, as shown in FIGS. 2A and 2B, the first outer diameter L11 of the first light shielding region B32 of the display panel 111 may be between 9.5 mm to 12.0 mm, for example, may be about 10.7 mm; the first inner diameter L12 of the first light shielding region B32 may be between 7.2 mm to 8.8 mm, for example, may be about 8.0 mm. The second outer diameter L21 of the second light shielding region C32 of the viewing angle control panel 12 may be between 9.2 mm to 11.5 mm, for example, may be about 10.4 mm; the second inner diameter L22 of the second light shielding region C32 may be between 7.4 mm to 9.2 mm, for example, may be about 8.3 mm. An unilateral bonding accuracy between the display panel 111 and the viewing angle control panel 12 may be less than or equal to 0.15 mm, for example, may be about 0.1 mm or 0.05 mm.

In some examples, as shown in FIGS. 2A and 2B, an aperture L32 of the second through hole 1330 of the backlight film material 133 may be greater than an aperture L31 of the first through hole 1310. A diameter L4 of the camera 141 may be smaller than the aperture L31 of the first through hole 1310 to ensure that the camera 141 can be normally assembled into the camera hole of the backlight module 13. The center position of the second through hole 1330, the center position of the first through hole 1310, and the center position of the camera 141 may coincide with each other, for example, all on the first axis OO′.

In some examples, as shown in FIGS. 2A and 2B, the aperture L32 of the second through hole 1330 of the backlight film material 133 may be between 8.8 mm to 11.0 mm, for example, may be about 9.9 mm. The aperture L31 of the first through hole 1310 of the backlight module 13 may be between 6.8 mm to 8.4 mm, for example, may be about 7.6 mm. The diameter L4 of the camera 141 may be between 6.3 mm to 7.7 mm, for example, may be about 7.0 mm. An unilateral reserved bonding accuracy between the camera assembly 14 and the backlight module 13 may be less than or equal to 0.45 mm, for example, may be about 0.3 mm or 0.15 mm.

In some examples, an orthographic projection of the second through hole 1330 on the viewing angle control panel 12 may be located within a range of an orthographic projection of the second hole region, and may cover the second light transmitting region C31, so that backlight enters the dimming region of the viewing angle control panel 12 and the backlight can be adjusted. A distance between the edge of the second through hole 1330 and the outer edge of the second light shielding region C32 of the viewing angle control panel 12 may be in a range of 0.22 mm to 0.28 mm, for example, may be about 0.25 mm. An unilateral bonding accuracy between the backlight module 13 and the viewing angle control panel 12 may be less than or equal to 0.15 mm, for example, may be about 0.1 mm or 0.05 mm.

In some examples, an orthographic projection of the camera 141 on the display panel 111 may be located within a range of an orthographic projection of the first light transmitting region B31, so as to ensure that the first light shielding region B32 of the display panel 111 does not cover the camera 141 and affect lighting of the camera 141. For example, an unilateral reserved bonding accuracy between the display panel 111 and the camera assembly 14 may be less than or equal to 0.8 mm, for example, may be about 0.5 mm or 0.25 mm.

In some examples, the viewing angle control panel 12 may be bonded to the backlight module 13 first, then bonded to the display module 11, to form a whole, and finally the whole is assembled with the camera assembly 14.

The display apparatus of the present example can realize the anti-peeping function by disposing the viewing angle control panel between the backlight module and the display module, and by disposing the first hole region and the second hole region in the display panel and the viewing angle control panel, respectively, and disposing the camera hole in the backlight module, the under-screen camera function can be realized after assembled with the camera assembly, thereby realizing compatible design of the anti-peeping and the under-screen camera functions, and improving user experience.

Hereinafter, a structure of the display panel will be described as an example. The display panel of the following example is illustrated by taking an HADS type liquid crystal cell as an example.

FIG. 5 is a schematic diagram of a structure of a display region of the display panel according to at least one embodiment of the present disclosure. In some examples, as shown in FIG. 5, the display region of the display panel may include: a plurality of first data lines 55 and a plurality of first gate lines 56. The plurality of first gate lines 56 may extend along the first direction X and be sequentially arranged along the second direction Y; the plurality of first data lines 55 may extend along the second direction Y and be sequentially arranged along the first direction X. The plurality of first data lines 55 and the plurality of first gate lines 56 may be located in different film layers.

In some examples, as shown in FIG. 5, the plurality of first data lines 55 and the plurality of first gate lines 56 may intersect to form a plurality of sub-pixel regions, and a region defined by intersections of adjacent first data lines 55 and adjacent first gate lines 56 may be one sub-pixel region. One display unit may correspondingly be disposed in one sub-pixel region. A plurality of display units may be arranged in an array in the display region. For example, the plurality of display units may include: a plurality of first display units that emit a first color light, a plurality of second display units that emit a second color light, and a plurality of third display units that emit a third color light. For example, the first color light may be red light, the second color light may be green light, and the third color light may be blue light. For example, the first display units, the second display units, and the third display units may be sequentially arranged along the first direction. However, the present embodiment is not limited thereto. In other examples, the first display units, the second display units, and the third display units may be arranged in other ways.

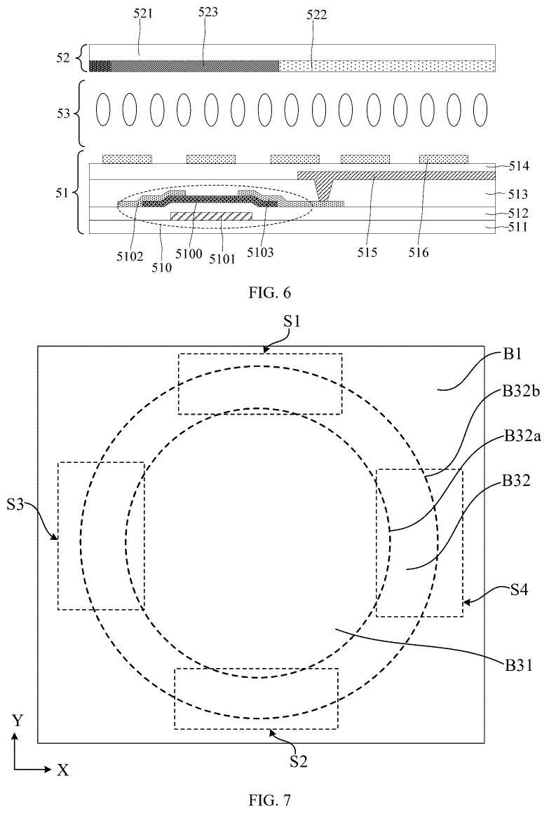

FIG. 6 is a schematic partial cross-sectional diagram of the display region of the display panel according to at least one embodiment of the present disclosure. In some examples, as shown in FIG. 6, in a direction perpendicular to the display panel, the display panel may include: a first base substrate 51, a second base substrate 52, and a first liquid crystal layer 53 disposed between the first base substrate 51 and the second base substrate 52. The first base substrate 51 may also be referred to as an array base substrate, and the second base substrate 52 may also be referred to as a color film base substrate.

In some examples, as shown in FIGS. 5 and 6, a display module of the display region may at least include a first control circuit, a first pixel electrode 515, a first common electrode, and a liquid crystal region of the first liquid crystal layer 53 corresponding to the first pixel electrode 515. The first control circuit is electrically connected with the first pixel electrode 515, a first data line 55, and a first gate line 56. The first control circuit may be configured to provide a signal transmitted by the first data line 55 to the first pixel electrode 515 under control of the first gate line 56. First common electrodes of the plurality of display units may be of an integral structure. By controlling voltages of the first pixel electrode 515 and the first common electrode, liquid crystal molecules in a corresponding liquid crystal region of the first liquid crystal layer 53 may be driven to be deflected to realize display.

The first control circuit, the first data line 55, the first gate line 56, the first pixel electrode 515, and the first common electrode of the display unit of the present example may all be disposed in the first base substrate 51, and the first pixel electrode 515 and the first common electrode may be located in different film layers, thereby avoiding mutual interference between a voltage of the first pixel electrode 515 and a voltage of the first common electrode, and improving signal accuracy of the first pixel electrode 515 and the first common electrode. In another examples, when the display panel is a TN type liquid crystal cell, the first pixel electrode may be disposed in the first base substrate, and the first common electrode may be disposed in the second base substrate; when the display panel is an IPS type liquid crystal cell, the first pixel electrode and the first common electrode may be disposed in the first base substrate and located in a same film layer.

In some examples, as shown in FIGS. 5 and 6, the first control circuit may include a first thin film transistor 510, and the first thin film transistor 510 may include: a first active layer 5100, a first gate electrode 5101, a first source electrode 5102, and a first drain electrode 5103, and the first source electrode 5102 and the first drain electrode 5103 may be in contact with the first active layer 5100, respectively. The first drain electrode 5103 of the first thin film transistor 510 may be electrically connected with the first pixel electrode 515.

In some examples, as illustrated in FIG. 6, the first base substrate 51 may include at least a first substrate 511, and a first conductive layer, a first insulation layer 512, a first semiconductor layer, a second conductive layer, a second insulation layer 513, a first transparent conductive layer, a third insulation layer 514, and a second transparent conductive layer. The first conductive layer, the first insulation layer 512, the first semiconductor layer, the second conductive layer, the second insulation layer 513, the first transparent conductive layer, the third insulation layer 514, and the second transparent conductive layer are sequentially disposed on the first substrate 511. The first conductive layer may also be referred to as a gate metal layer, the first insulation layer 512 may also be referred to as a gate insulation layer, the second conductive layer may also be referred to as a source-drain metal layer, and the second insulation layer 513 and the third insulation layer 514 may also be referred to as planarization layers.

In some examples, the first insulation layer 512 may be an inorganic insulation layer, and the second insulation layer 513 and the third insulation layer 514 may be organic insulation layers. For example, the first insulation layer 512 may be made of any one or more of silicon oxide (SiOx, x>0), silicon nitride (SiNy, y>0), and silicon oxynitride (SiON), and may be a single layer, a multilayer layer, or a composite layer. The second insulation layer 513 and the third insulation layer 514 may be made of organic material, such as polyimide, acrylic, or polyethylene terephthalate. However, the present embodiment is not limited thereto. For example, all of the first insulation layer 512, the second insulation layer 513, and the third insulation layer 514 may be inorganic insulation layers.

In some examples, as shown in FIG. 6, the first conductive layer may include: a first gate electrode 5101 of the first thin film transistor 510 and a first gate line. The first gate line and the first gate electrode 5101 of the first thin film transistor 510 to which the first gate line is connected may be interconnected to form an integral structure. The first semiconductor layer may include: the first active layer 5100 of the first transistor 510. The second conductive layer may include at least: the first source electrode 5102 and the first drain electrode 5103 of the first thin film transistor 510, and a first data line. The first data line and the first source electrode 5102 of the first thin film transistor 510 to which the first data line is connected may be interconnected to form an integral structure. The first transparent conductive layer may include at least: a first pixel electrode 515. The second transparent conductive layer may include: a first common electrode 516. The first source electrode 5102 and the first drain electrode 5103 of the first thin film transistor 510 may be in direct contact with both ends of the first active layer 5100, respectively, to achieve connection. The first pixel electrode 515 may be electrically connected with the first drain electrode 5103 of the first thin film transistor 510 through a via opened in the second insulation layer 513.

In some examples, the first pixel electrode 515 and the first common electrode 516 may each be a comb structure including a plurality of strip-like sub-electrodes. However, the present embodiment is not limited thereto.

In some examples, the first conductive layer and the second conductive layer may be made of a metal material, such as any one or more of Argentum (Ag), Copper (Cu), Aluminum (Al), Titanium (Ti), and Molybdenum (Mo), or an alloy material of the aforementioned metals, such as an Aluminum-Neodymium alloy (AlNd) or a Molybdenum-Niobium alloy (MoNb), and may be of a single layer structure, or a multi-layer composite structure such as Mo/Cu/Mo, Ti/Al/Ti, etc. For example, a material of the first conductive layer may include Mo, and a material of the second conductive layer may be a stacked structure of Ti/Al/Ti. The first transparent conductive layer and the second transparent conductive layer may be made of a transparent conductive material such as Indium Tin Oxide (ITO) or Indium Zinc Oxide (IZO). The semiconductor layer may be made of one or more materials, such as amorphous Indium Gallium Zinc Oxide (a-IGZO), Zinc Oxynitride (ZnON), Indium Zinc Tin Oxide (IZTO), amorphous Silicon (a-Si), polycrystalline Silicon (p-Si), sexithiophene, and polythiophene. That is, the present disclosure is applicable to transistors manufactured based on an oxide technology, a silicon technology, and an organic matter technology.

In some examples, the first base substrate 51 may further include a transparent first rubbing film located on a side of the second transparent conductive layer away from the first substrate 511. A material of the first rubbing film may be polyimide, polyamide, polyethylene, polystyrene, or polyvinyl alcohol, etc.

In some examples, as shown in FIG. 6, the second base substrate 52 may include: a second substrate 521, a plurality of filter units of different colors (e.g., including a filter unit 522) disposed on the second substrate 521, and a first black matrix 523 located between the different filter units. The plurality of filter units may include at least a plurality of red filter units, a plurality of green filter units and a plurality of blue filter units. The plurality of color filter units may correspond one-to-one with the plurality of display units on the first base substrate 51. For example, the first display units may correspond to the red filter units, and orthographic projections of the red filter units on the first substrate are at least partially overlapped with orthographic projections of the first display units on the first substrate. The second display units may correspond to the green filter units, and orthographic projections of the green filter units on the first substrate are at least partially overlapped with orthographic projections of the second display units on the first substrate. The third display units may correspond to the blue filter units, and orthographic projections of the blue filter units on the first substrate are at least partially overlapped with orthographic projections of the third display units on the first substrate. In the present example, a filter unit can make light of a single color pass through and absorb light of other colors. For example, a blue filter unit can let blue light pass through and absorb light of other colors.

In some examples, the first black matrix 523 may be configured to separate the plurality of filter units to prevent light mixing. For example, the first black matrix 523 may be provided with a plurality of first openings, the plurality of first openings may correspond one-to-one with the plurality of filter units, and each first opening may be provided with one filter unit correspondingly.

In some examples, the second base substrate 52 may further include a second rubbing film located on a side of the plurality of filter units and the first black matrix 523 away from the second substrate 521. The first rubbing film and the second rubbing film may be used to control the deflection directions of the liquid crystal molecules of the first liquid crystal layer. For example, the first rubbing film and the second rubbing film may be used to control the deflection directions of the liquid crystal molecules without an action of an electric field, and it can also be understood that the first rubbing film and the second rubbing film are used to define a pretilt angle of the liquid crystal molecules.

In some examples, one sub-pixel region of the display panel may include an opening region and a non-opening region surrounding the opening region. The non-opening region may be a region shielded by the first black matrix 523 of the second base substrate 52, and the opening region may be a region of the second base substrate 52 not shielded by the first black matrix 523. Adjacent first gate lines 56 and first data lines 55 located in the first substrate 51 may all be located in the non-opening region. The display panel in this embodiment may be configured to implement a display function, and an opening region of each sub-pixel region may be configured for displaying. The non-opening region surrounds the opening region, and does not perform displaying.

FIG. 7 is a planar schematic diagram of a first hole region of the display panel according to at least one embodiment of the present disclosure. In some examples, as shown in FIG. 7, the first light shielding region B32 of the first hole region of the display panel may have an inner edge B32a and an outer edge B32b, the inner edge B32a of the first light shielding region B32 is an edge of the first light transmitting region B31, and the outer edge B32b of the first light shielding region B32 is connected with the display region B1.

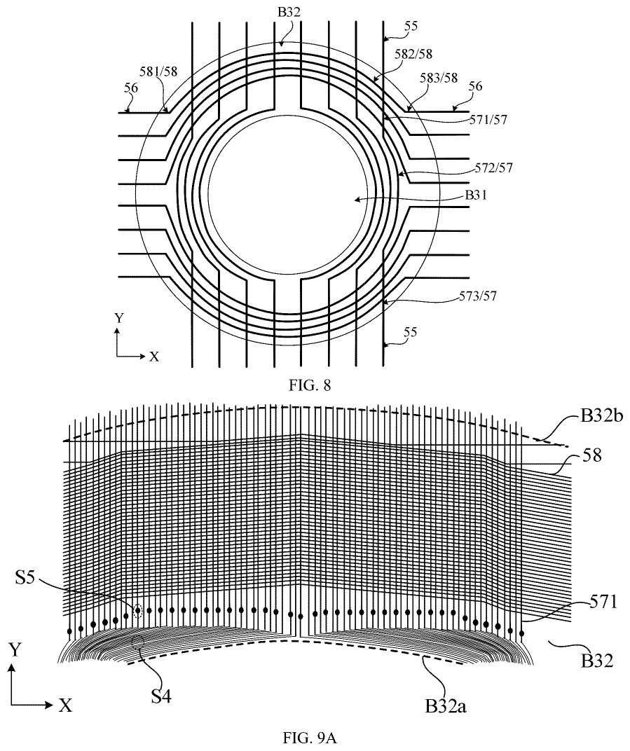

FIG. 8 is a schematic diagram of wiring of the first hole region of the display panel according to at least one embodiment of the present disclosure. In some examples, as shown in FIG. 8, the first light shielding region B32 of the first hole region may include at least a plurality of first gate connection lines 58 and a plurality of first data connection lines 57. The first gate lines 56 in the display region around the first hole region are wound through the first gate connection lines 58 to bypass the first light transmitting region B31 of the first hole region; the first data lines 55 in the display region around the first hole region are wound by the first data connection lines 57 to bypass the first light transmitting region B31 of the first hole region.

In some examples, as shown in FIG. 8, the first gate lines 56 located in the display region on both sides of the first light shielding region B32 along the first direction X may be electrically connected by the first gate connection lines 58. For example, a first gate line 56 connected to one row of display units located in a left display region of the first light shielding region B32 may be electrically connected with a first gate line 56 connected to a same row of display units located in a right display region through a first gate connection line 58. The plurality of first gate connection lines 58 may be divided into two groups, a first group of first gate connection lines 58 may be located in a upper half region of the first light shielding region B32 to enable winding from a upper side of the first light transmitting region B31, and a second group of first gate connection lines 58 may be located in a lower half region of the first light shielding region B32 to enable winding from a lower side of the first light transmitting region B31.

In some examples, as shown in FIG. 8, a first gate connection line 58 may include a first extension segment 581, a second extension segment 582, and a third extension segment 583 sequentially connected. The first extension segment 581 and the third extension segment 583 may be straight line segments extending along the first direction X, the second extension segment 582 may be an arc line segment extending along the first direction X, and the second extension segment 582 may also be referred to as a first arc line segment. For example, a shape of the second extension 582 may match a local shape of the inner edge of the first light shielding region B32. The plurality of first gate connection lines 58 may be arranged close to the outer edge of the first light shielding region B32.

In some examples, as shown in FIG. 8, the first data lines 55 located in the display region on both sides of the first light shielding region B32 along the second direction Y may be electrically connected by the first data connection lines 57. For example, a first data line 55 to which one column of display units in an upper display region of the first light shielding region B32 is connected may be electrically connected with a first data line 55 to which a same column of display units in a lower display region is connected through a first data connection line 57. The plurality of first data connection lines 57 may be divided into two groups, a first group of first data connection lines 57 may be located in a left region of the first light shielding region B32 to enable winding from a left side of the first light transmitting region B31, and a second group of first data connection lines 57 may be located in a right region of the first light shielding region B32 to enable winding from a right side of the first light transmitting region B31.

In some examples, as shown in FIG. 8, a first data connection line 57 may include a fourth extension segment 571, a fifth extension segment 572, and a sixth extension segment 573 sequentially connected. The fourth extension segment 571 and the sixth extension segment 573 may be straight line segments extending along the second direction Y, the fifth extension segment 572 may be an arc line segment extending along the second direction Y, and the fifth extension segment 572 may also be referred to as a second arc line segment. For example, a shape of the fifth extension 572 may match a local shape of the inner edge of the first light shielding region B32. An orthographic projection of the fourth extension 571 on the first substrate may be overlapped with orthographic projections of the first group of first gate connection lines on the first substrate, an orthographic projection of the sixth extension 573 on the first substrate may be overlapped with orthographic projections of the second group of first gate connection lines on the first substrate, and an orthographic projection of the fifth extension 572 on the first substrate may be not overlapped with orthographic projections of the plurality of first gate connection lines 58 on the first substrate. The fifth extension segment 572 may be located on a side of the plurality of first gate connection lines 58 close to the first light transmitting region B31.

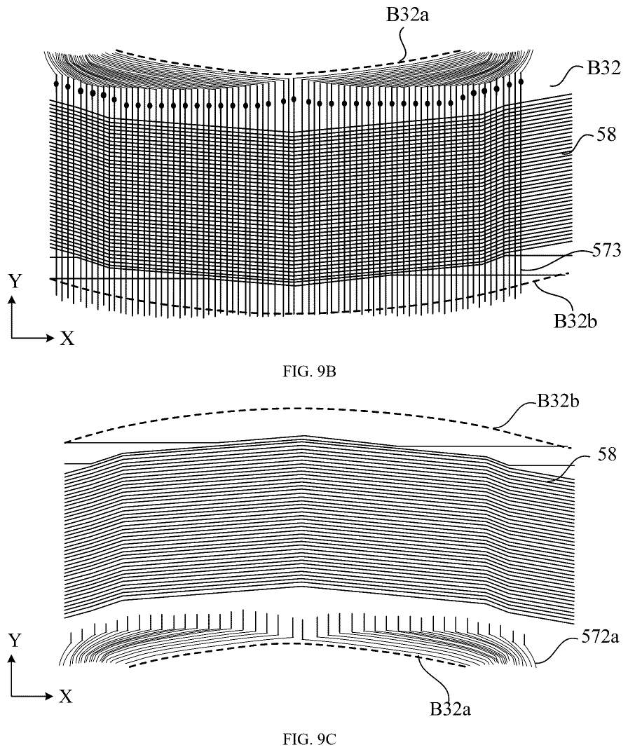

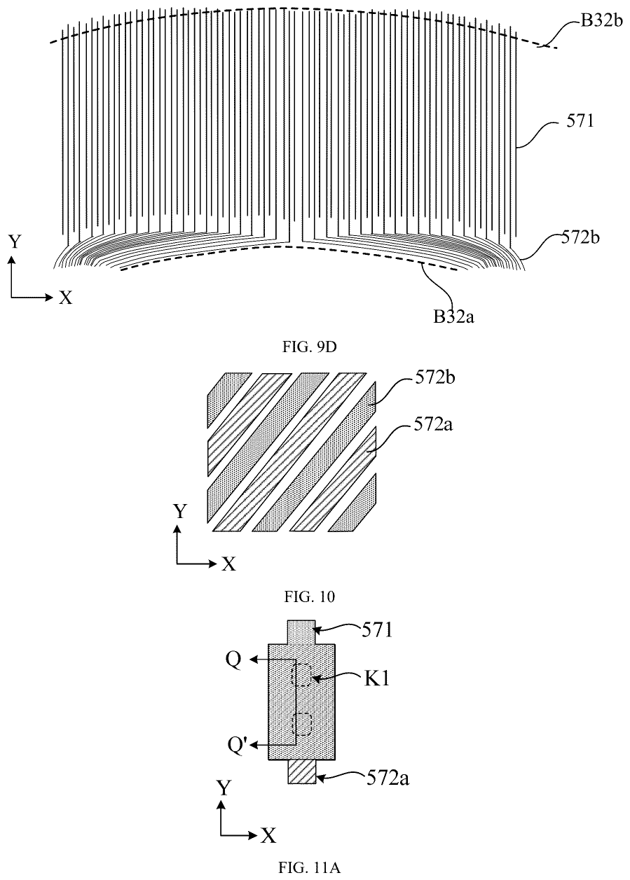

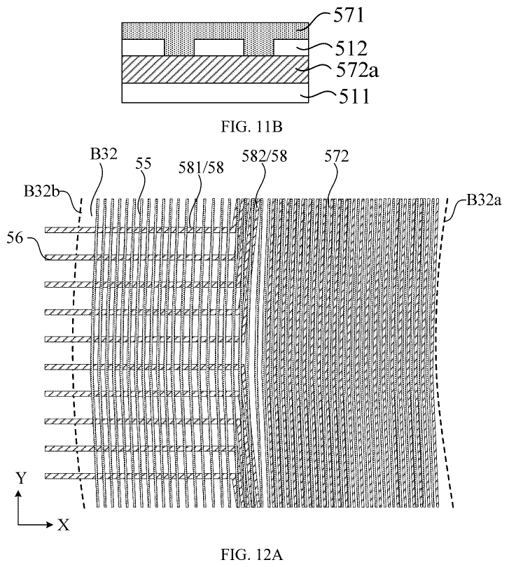

FIG. 9A is a schematic partial enlarged diagram of a region S1 in FIG. 7. FIG. 9B is a schematic partial enlarged diagram of a region S2 in FIG. 7. FIG. 9C is a schematic partial diagram of wiring in a first conductive layer of FIG. 9A. FIG. 9D is a schematic partial diagram of wiring in a second conductive layer of FIG. 9A. FIG. 10 is a schematic partial enlarged diagram of a region S4 in FIG. 9A. FIG. 11A is a schematic partial enlarged diagram of a region S5 in FIG. 9A. FIG. 11B is a schematic cross-sectional diagram taken along a direction Q-Q′ in FIG. 11.

In some examples, as shown in FIGS. 9A to 11B, the plurality of fifth extension segments of the first data connection lines 57 may be alternately arranged in different film layers. For example, the plurality of fifth extension segments may include: a plurality of fifth extension segments 572a located in the first conductive layer and a plurality of fifth extension segments 572b located in the second conductive layer. The plurality of fifth extension segments 572a and the plurality of fifth extension segments 572b may be arranged at intervals. Orthographic projections of the plurality of fifth extension segments 572a and the plurality of fifth extension segments 572b on the first substrate may not overlap. In this example, the plurality of fifth extension segments are arranged in two different film layers, which can be beneficial for reducing the occupied space of the first data connection lines, thereby beneficial for reducing the size of the first light shielding region, and improving the display effect of the display panel.

In some examples, as shown in FIGS. 9A to 11B, a fourth extension segment 571 and a sixth extension segment 573 of a first data connection line 57 may be of a same layer structure, for example, may both be located in the second conductive layer. The fourth extension segment 571 and a fifth extension segment 572b to which the fourth extension segment 571 is connected may be interconnected in an integral structure. The fourth extension segment 571 may be electrically connected to a fifth extension segment 572a located in the first conductive layer through at least one first via K1 (for example, two first vias K1) opened in the first insulation layer 512. In some examples, a width of an end of the fifth extension 572a may be greater than a line width of the extension segment of the fifth extension segment 572a, and a width of an end of the fourth extension segment 571 may be greater than a line width of the extension segment of the fourth extension segment 571 to facilitate an implementation of perforated connections. A connection mode of the fifth extension portion 572a and the sixth extension portion is similar to this, and therefore the description thereof will not be repeated here.

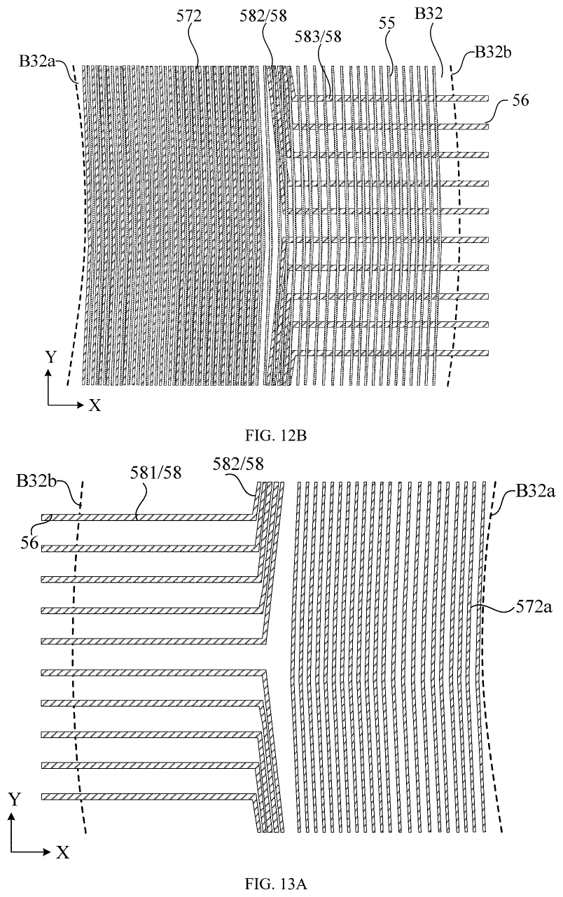

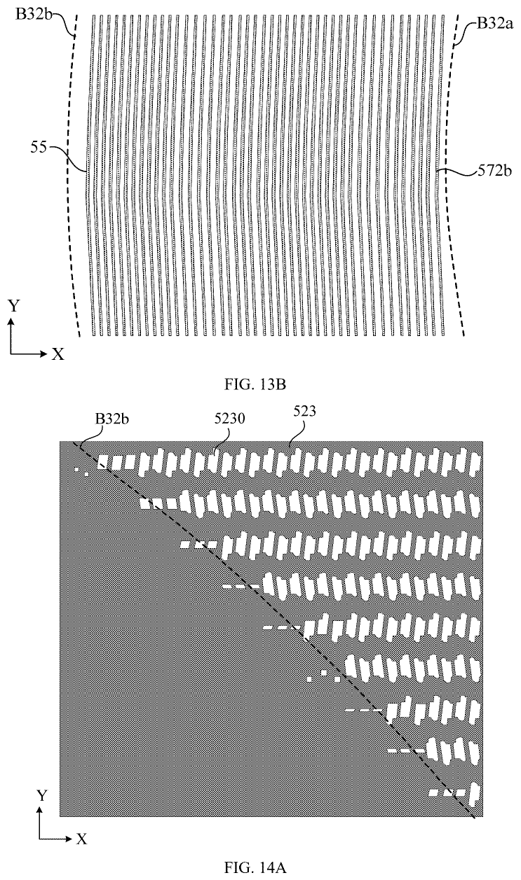

FIG. 12A is a schematic partial enlarged diagram of a region S3 in FIG. 7. FIG. 12B is a schematic partial enlarged diagram of a region S4 in FIG. 7. FIG. 13A is a schematic diagram of a first conductive layer of FIG. 12A. FIG. 13B is a schematic diagram of a second conductive layer of FIG. 12A.

In some examples, as shown in FIGS. 12A to 13B, the fifth extension segments 572 of the first data connection lines may be located on a side of the first extension segments 581 or the third extension segments 583 of the first gate connection lines 58 close to the first light transmitting region. The fifth extension segments 572a and the fifth extension segments 572b may be alternately arranged along the first direction X, and the fifth extension segments 572a and the fifth extension segments 572b are adjacent to the inner edge B32a of the first light shielding region. On a side of the fifth extension segments 572 away from the inner edge B32a of the first light shielding region, the first data lines 55 passing through the first light shielding region along the second direction Y may be provided. The first data lines 55 passing through the first light shielding region do not need to be wound. Orthographic projections of the first data lines 55 located in the first light shielding region on the first substrate may be overlapped with the orthographic projections of the plurality of first gate connection lines 58 on the first substrate.

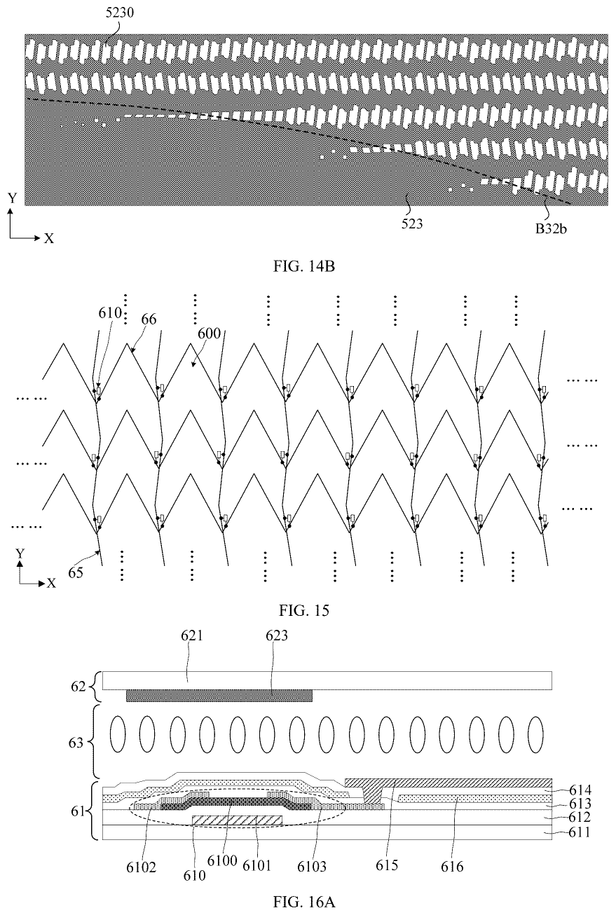

FIGS. 14A and 14B are planar schematic partial diagrams of a first black matrix according to at least one embodiment of the present disclosure. In some examples, as shown in FIGS. 14A and 14B, an orthographic projection of the first black matrix 523 of the second base substrate on the first substrate may cover orthographic projections of all wirings in the first light shielding region on the first substrate, so that the first light shielding region does not display.

In some examples, as shown in FIGS. 14A and 14B, the first black matrix 523 of the second base substrate may have a plurality of first openings 5230. The plurality of first openings 5230 may correspond one-to-one with the plurality of filter units, and each first opening 5230 may be provided with one filter unit correspondingly. The first openings 5230 may be configured to correspond to the display region with the display units. In an overlapping region between the display region and the first light shielding region (such as near the outer edge B32b of the first light shielding region), sizes of the first openings 5230 close to the display region may be greater than sizes of the first openings 5230 close to the first light shielding region. The plurality of first openings 5230 may have different shapes of orthographic projections on the first substrate, and the different shapes of orthographic projections may include, for example, a flag shape, a parallelogram shape, a rectangle shape, or the like. A size of a first opening 5230 may include an area of the first opening 5230.

In some examples, as illustrated in FIG. 14B, in a region in which the outer edge B32b of the first light shielding region is located, in the first direction X, sizes of the plurality of first openings 5230 corresponding to the plurality of display units sequentially arranged along the first direction X may gradually increase in a direction close to the display region. For example, in the region in which the outer edge B32b of the first light shielding region is located, along a direction parallel to the first direction X and close to the display region, shapes of the plurality of first openings 5230 may be rectangular, parallelogram, and flag shape in sequence, and areas of the plurality of first openings may gradually increase. As shown in FIG. 14A, in the region in which the outer edge B23b of the first light shielding region is located, in the second direction Y, sizes of the plurality of first openings 5230 corresponding to the plurality of display units arranged sequentially along the second direction Y may gradually increase in a direction close to the display region. For example, in the region in which the outer edge B32b of the first light shielding region is located, along a direction parallel to the second direction Y and close to the display region, shapes of the plurality of first openings 5230 may be rectangular, parallelogram, and flag shape in sequence, and areas of the plurality of first openings 5230 may gradually increase.

In the display panel of the present example, by setting the sizes of the first openings of the first black matrix in a boundary region between the first light shielding region and the display region, and combining a gray-scale optimization adjustment of the display units, a display gray-scale optimization can be realized, the outer edge of the first light shielding region is prevented from being macroscopically jagged during display, and the display effect of the display panel can be improved.

FIG. 15 is a schematic diagram of a structure of a dimming region of the viewing angle control panel according to at least one embodiment of the present disclosure. In some examples, as shown in FIG. 15, the dimming region of the viewing angle control panel may include a plurality of second data lines 65 and a plurality of second gate lines 66. The plurality of second gate lines 66 may be in shapes of broken lines extending along the first direction X, and may be sequentially arranged in the second direction Y. The plurality of second data lines 65 may be in shapes of broken lines extending in the second direction Y, and may be sequentially arranged in the first direction X. The plurality of second data lines 65 and the plurality of second gate lines 66 may be located in different film layers. The second data lines 65 and second gate lines 66 of the present example adopt a broken line design, which may be beneficial for the viewing angle control panel to reduce or even eliminate a moire problem of the display apparatus.

In some examples, as shown in FIG. 15, the plurality of second data lines 65 and the plurality of second gate lines 66 may intersect to form a plurality of sub-dimming regions 600, and a region defined by intersections of adjacent second data lines 65 and adjacent second gate lines 66 may be one sub-dimming region 600. Or, it can be understood that orthographic projections of any two adjacent second data lines 65 and any two adjacent second gate lines 66 intersect to form a closed grid, and the grid forms a sub-dimming region 600. The sub-dimming region 600 may be configured to switch between a shared state and an anti-peeping state, in other words, the sub-dimming region 600 is a smallest unit in which the viewing angle control panel can switch a display state. A dimming unit may be disposed in a sub-dimming region 600. A plurality of dimming units may be arranged in an array in the display region. The sub-dimming region 600 may be a substantially V-shaped region.

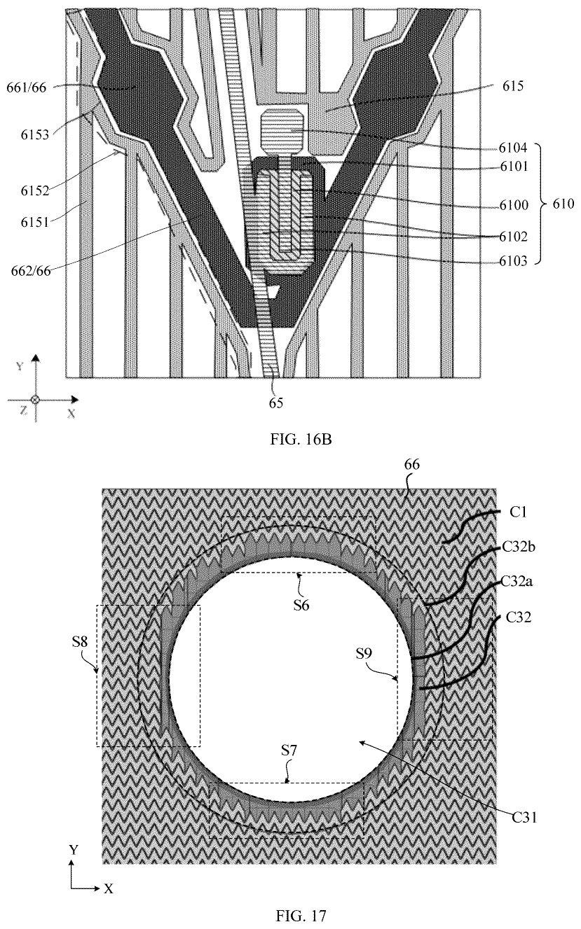

FIG. 16A is a schematic partial cross-sectional diagram of the dimming region of the viewing angle control panel according to at least one embodiment of the present disclosure. FIG. 16B is a planar schematic partial diagram of the dimming region of the viewing angle control panel according to at least one embodiment of the present disclosure.

In some examples, as shown in FIG. 16A, in a direction perpendicular to the viewing angle control panel, the viewing angle control panel may include: a third base substrate 61, a fourth base substrate 62, and a second liquid crystal layer 63 disposed between the third base substrate 61 and the fourth base substrate 62. The third base substrate 61 may also be referred to as an array base substrate.

In some examples, as illustrated in FIGS. 15 and 16A, a dimming unit in the dimming region may include at least: a second control circuit, a second pixel electrode 615, a second common electrode 616, and a liquid crystal region of the second liquid crystal layer 63 corresponding to the second pixel electrode 615. The second control circuit is electrically connected with the second pixel electrode 615, a second data line 65, and a second gate line 66. The second control circuit may be configured to provide a signal transmitted by the second data line 65 to the second pixel electrode 615 under control of the second gate line 66. The second common electrodes of the plurality of dimming units may be of an integral structure. By controlling voltages of the second pixel electrode 615 and the second common electrode 616, states of the liquid crystal molecules corresponding to sub-dimming regions can be controlled, wherein the liquid crystal molecules are in the first liquid crystal layer 53.

In some examples, as shown in FIGS. 15, 16A, and 16B, the second control circuit may include a second thin film transistor 610. The second thin film transistor 610 may include a second active layer 6100, a second gate electrode 6101, a second source electrode 6102, and a second drain electrode 6103. The second source electrode 6102 and the second drain electrode 6103 may be in contact with the second active layer 6100, respectively. The second drain electrode 6103 of the second thin film transistor 610 may be electrically connected with the second pixel electrode 615.

In some examples, as illustrated in FIG. 16A, the third base substrate 61 may include at least: a third substrate 611, and a third conductive layer, a fourth insulation layer 612, a second semiconductor layer, a fourth conductive layer, a fifth insulation layer 613, a third transparent conductive layer, a sixth insulation layer 614, and a fourth transparent conductive layer. The third conductive layer, the fourth insulation layer 612, the second semiconductor layer, the fourth conductive layer, the fifth insulation layer 613, the third transparent conductive layer, the sixth insulation layer 614, and the fourth transparent conductive layer are sequentially disposed on the third substrate 611. The third conductive layer may also be referred to as a gate metal layer, the fourth insulation layer 612 may also be referred to as a gate insulation layer, the fourth conductive layer may also be referred to as a source-drain metal layer, and the fifth insulation layer 613 and the sixth insulation layer 614 may also be referred to as passivation layers. For example, the fourth insulation layer 612, the fifth insulation layer 613, and the sixth insulation layer 614 may all be inorganic insulation layers.

In some examples, as shown in FIGS. 16A and 16B, the third conductive layer may include: the second gate electrode 6101 of the second thin film transistor 610 and a second gate line 66. The second gate line 66 and the second gate electrode 6101 of the second thin film transistor 610 to which the second gate line 66 is connected may be interconnected to form an integral structure. The second semiconductor layer may include the second active layer 6100 of the second thin film transistor 610. The fourth conductive layer may at least include: the second source electrode 6102 and the second drain electrode 6103 of the second thin film transistor 610 and a second data line 65. The second data line 65 and the second source electrode 6102 of the second thin film transistor 610 to which the second data line 65 is connected may be interconnected to form an integral structure. The third transparent conductive layer may at least include: the second common electrode 616. The fourth transparent conductive layer may include the second pixel electrode 615. The second source electrode 6102 and the second drain electrode 6103 of the second thin film transistor 610 may be in direct contact with both ends of the second active layer 6100, respectively, to achieve connection. The second pixel electrode 615 may be electrically connected with the second drain electrode 6103 of the second thin film transistor 610 through vias opened in the sixth insulation layer 614 and the fifth insulation layer 613.

In some examples, as shown in FIG. 16B, the second pixel electrode 615 may include a plurality of first electrode strips 6151 disposed at intervals along the first direction X, and a second electrode strip 6152 connected end-to-end. The first electrode strips 6151 extend along the second direction Y. The second electrode strip 6152 is connected with both ends of the first electrode strips 6151 in the second direction Y to form a structure in which the second electrode strip 6152 surrounds the plurality of first electrode strips 6151. The plurality of first electrode strips 6151 may be connected to form an integral structure by the second electrode strip 6152. When a first electrode strip 6151 is connected with the second thin film transistor 610, all of the plurality of first electrode strips 6151 may be electrically connected with the second thin film transistor 610 as long as one place is electrically connected with the second thin film transistor 610, so that the second thin film transistor 610 may charge the plurality of first electrode strips 6151. An edge of a second electrode strip 6152 close to the second gate line 66 may be provided with a first groove 6153, and an orthographic projection of the first groove 6153 on the third substrate may be spaced from an orthographic projection of the second gate line 66 on the third substrate.

In some examples, as illustrated in FIG. 16B, the second gate line 66 may include a plurality of light adjustment portions 661 and a connection portion 662 connected with the light adjustment portions 661. A width of a light adjustment portion 661 (for example, a length along a direction perpendicular to an extending direction of the light adjusting portion) may be greater than a width of a connection portion 662 (for example, a length along a direction perpendicular to an extending direction of the connection portion). The light adjustment portion 661 can increase the irregularity of a shape of the second gate line 66, and for example, a boundary of the second gate line 66 may be substantially jagged. The light adjustment portion 661 can increase a difference between a grid formed by the second gate line 66 and a grid on the display panel, thereby facilitating alleviation of the moire problem of the display apparatus.

In some examples, as shown in FIG. 16A, the fourth base substrate 62 may include: a fourth substrate 621, and a second black matrix 623 disposed on the fourth substrate 621. An orthographic projection of the second black matrix 623 on the third substrate may cover orthographic projections of the wiring in the third substrate and the second thin film transistor on the third substrate.

The rest of the film layer structure of the viewing angle control panel of the present example can be referred to the description of the display panel, and therefore, the description thereof will not be repeated here.

In some examples, the viewing angle control panel may be configured to adjust a propagation direction of light passing through the viewing angle control panel, thereby controlling a light emission direction from the display panel to cause the display apparatus to display an image in at least one of the anti-peeping state and the shared state. The viewing angle control panel can operate in a transparent or scattering state. When the viewing angle control panel is operated in a transparent state (or referred as a transmission state), a long axis direction of the liquid crystal molecules in the second liquid crystal layer may be parallel to the third direction Z (i.e. the direction perpendicular to the viewing angle control panel), and the viewing angle control panel does not change a propagation direction of the light passing through the viewing angle control panel. In this way, the light emitted by the backlight module into the viewing angle control panel still passes through the viewing angle control panel in a direction perpendicular to the display panel, and then enters and passes through the display panel. A propagation direction of the light of the display side of the display panel is perpendicular to a light emission surface of the display panel. Only in a region directly facing the display panel (a line of sight is perpendicular to the display panel), display contents of the display panel can be seen, and in a region located in periphery (surrounding region) of the display panel, the contents displayed by the display panel cannot be seen or cannot be clearly seen. In this case, the display panel can prevent people around from looking at it, in other words, the display apparatus displays the image in the anti-peeping state.

In some examples, when the viewing angle control panel is operated in the scattering state, the long axis direction of the liquid crystal molecules in the second liquid crystal layer may have an included angle with the third direction Z (i.e. a direction perpendicular to the viewing angle control panel), and the viewing angle control panel may change a propagation direction of light passing through the viewing angle control panel and cause the light to be emitted in a scattering state. In this way, light from the backlight module enters the viewing angle control panel in the direction perpendicular to the viewing angle control panel, passes through the viewing angle control panel, and then enters and passes through the display panel in the scattering state, and the light of the display side of the display panel is diverged to the surroundings. In this case, display contents of the display panel can be seen from both the region directly facing the display panel and the region located in the periphery of the display panel, and the display apparatus displays in the shared state.

In some examples, the second liquid crystal layer 63 may adopt a liquid crystal dimming film. For example, Polymer Dispersed Liquid Crystal (PDLC) may be used. Polymer Dispersed Liquid Crystal mainly operates in a transparent state or a scattering state. For example, Polymer Dispersed Liquid Crystal mixes low liquid crystal molecules with prepolymer glue, and through polymerization, micron-sized liquid crystal droplets are formed and uniformly dispersed in the polymer network, and then the dielectric anisotropy of the liquid crystal molecules is used to obtain materials with corresponding electro-optical properties. In the present embodiment, the material of the second liquid crystal layer is not limited as long as the material of the second liquid crystal layer is a liquid crystal that can be switched between a transparent state and a scattering state. As another example, the liquid crystal in the second liquid crystal layer may adopt a smectic liquid crystal.

In some examples, the viewing angle control panel may further include: a third rubbing film disposed on a side of the third base substrate 61 close to the second liquid crystal layer 63, and a fourth rubbing film disposed on a side of the fourth base substrate 62 close to the second liquid crystal layer 63. The third rubbing film and the fourth rubbing film may be used to control the deflection directions of the liquid crystal molecules of the second liquid crystal layer, for example, the third rubbing film and the fourth rubbing film may be used to control the deflection directions of the liquid crystal molecules without an action of an electric field, and it can also be understood that the third rubbing film and the fourth rubbing film are used to define the pretilt angle of the liquid crystal molecules.

FIG. 17 is a planar schematic diagram of a second hole region of the viewing angle control panel according to at least one embodiment of the present disclosure. In some examples, as shown in FIG. 17, the second light shielding region C32 of the second hole region of the viewing angle control panel may have an inner edge C32a and an outer edge C32b, the inner edge C32a of the second light shielding region C32 is the edge of the second light transmitting region C31, and the outer edge C32b of the second light shielding region C32 is connected with the dimming region C1.

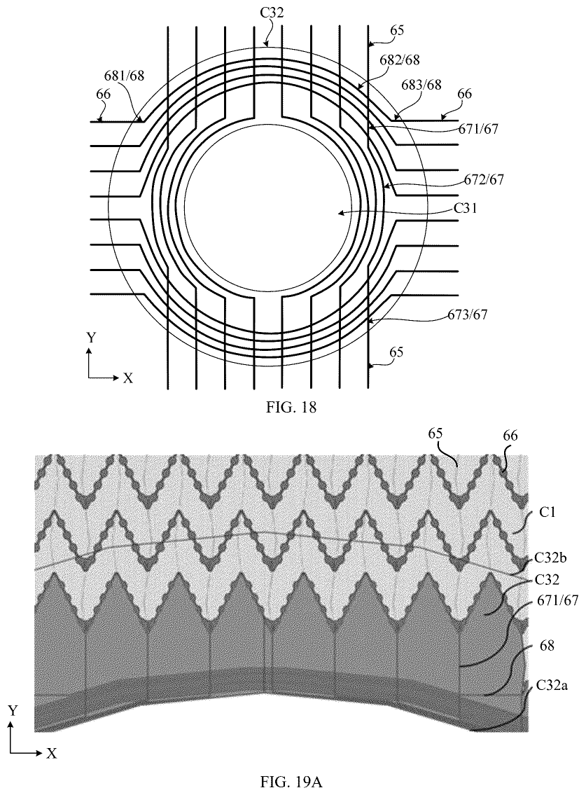

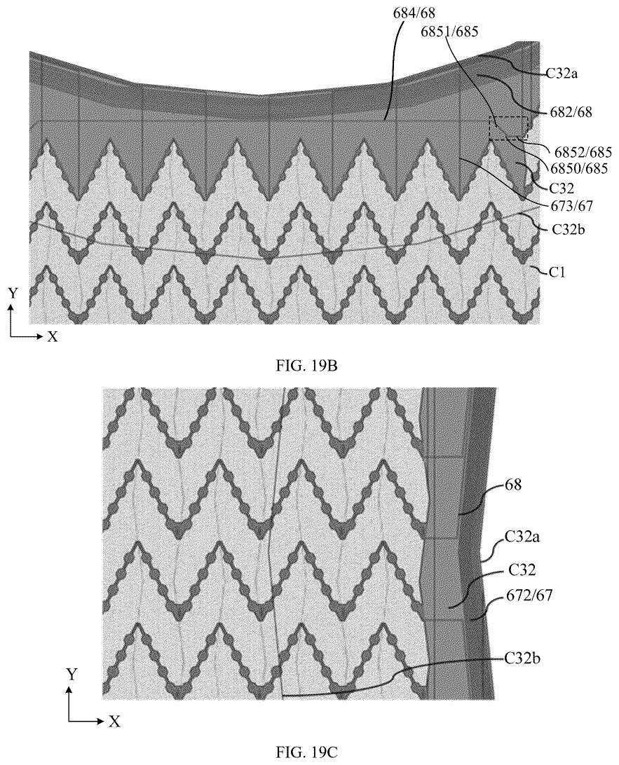

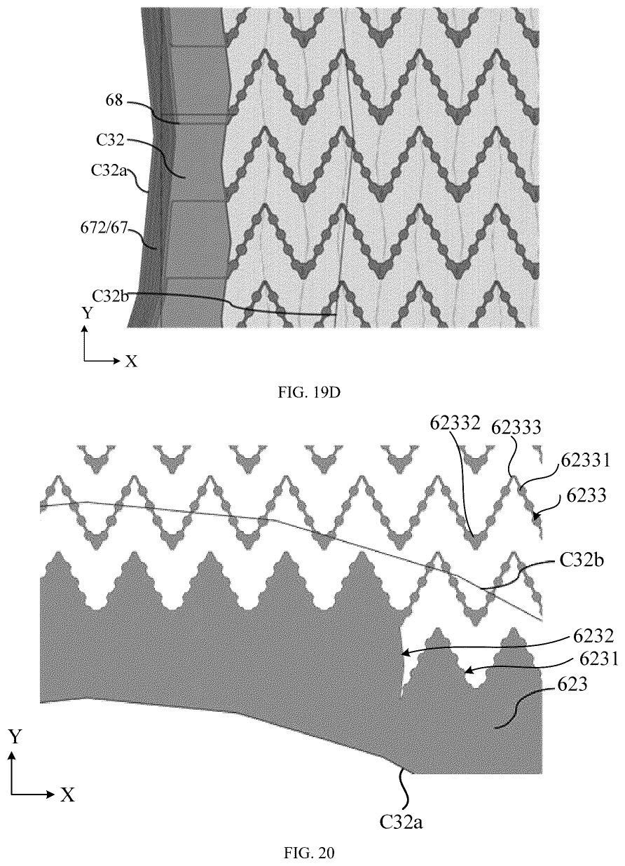

FIG. 18 is a schematic diagram of wiring in the second hole region of the viewing angle control panel according to at least one embodiment of the present disclosure. FIG. 19A is a schematic partial enlarged diagram of a region S6 in FIG. 17. FIG. 19B is a schematic partial enlarged diagram of a region S7 in FIG. 17. FIG. 19C is a schematic partial enlarged diagram of a region S8 in FIG. 17. FIG. 19D is a schematic partial enlarged diagram of a region S9 in FIG. 17.

In some examples, as shown in FIGS. 18 to 19D, the second light shielding region C32 of the second hole region may at least include: a plurality of second gate connection lines 68 and a plurality of second data connection lines 67. The second gate lines 66 in the dimming region around the second hole region are wound through the second gate connection lines 68 to bypass the second light transmitting region C31 of the second hole region; the second data lines 65 in the dimming region around the second hole region are wound through the second data connection lines 67 to bypass the second light transmitting region C31 of the second hole region.

In some examples, the second gate lines 66 located within the dimming region on both sides of the second light shielding region C32 along the first direction X may be electrically connected by the second gate connection lines 68. For example, a second gate line 66 connected to a row of dimming units located in the left dimming region of the second light shielding region C32 may be electrically connected to a second gate line 66 connected to a same row of dimming units in the right dimming region through a second gate connection line 68. The plurality of second gate connection lines 68 may be divided into two groups, so that a first group of second gate connection lines 68 may be located in the upper half region of the second light shielding region C32 to enable winding from the upper side of the second light transmitting region C31, and a second group of second gate connection lines 68 may be located in the lower half region of the second light shielding region C32 to enable winding from the lower side of the second light transmitting region C31.

In some examples, as shown in FIGS. 18 to 19D, a second gate connection line 68 may include a seventh extension segment 681, an eighth extension segment 682, and a ninth extension segment 683 sequentially connected. The seventh extension segment 681 and the ninth extension segment 683 may be straight line segments extending along the first direction X, the eighth extension segment 682 may be an arc line segment extending along the first direction X, and the eighth extension segment 682 may also be referred to as a third arc line segment. For example, a shape of the eighth extension segment 682 may match a local shape of the inner edge of the second light shielding region C32. The plurality of second gate connection lines 68 may be arranged close to the outer edge of the second light shielding region C32. For example, a seventh extension segment 681, an eighth extension segment 682, and a ninth extension segment 683 of a second gate connection line 68 may be of a sequentially connected integral structure, for example, the sequentially connected integral structure may be located in the third conductive layer of the third base substrate. The second gate connection line 68 and a second gate line 66 to which the second gate connection line 68 is connected may be of an interconnected integral structure.

In some examples, as shown in FIGS. 18 to 19D, the second data lines 65 located in the dimming region on both sides of the second light shielding region C32 along the second direction Y may be electrically connected by the second data connection lines 67. For example, a second data line 65 connected to one column of light dimming units in the upper light dimming region of the second light shielding region C32 may be electrically connected to a second data line 65 connected to a same column of light dimming units in the lower light dimming region through a second data connection line 67. The plurality of second data connection lines 67 may be divided into two groups, so that a first group of second data connection lines 67 may be located in a left region of the second light shielding region C32 to enable winding from a left side of the second light transmitting region C31, and a second group of second data connection lines 67 may be located in a right region of the second light shielding region C32 to enable winding from a right side of the second light transmitting region C31.

In some examples, as shown in FIGS. 18 to 19D, a second data connection line 67 may include a tenth extension segment 671, an eleventh extension segment 672, and a twelfth extension segment 673 sequentially connected. The tenth extension segment 671 and the twelfth extension segment 673 may be straight line segments extending along the second direction Y, the eleventh extension segment 672 may be an arc line segment extending along the second direction Y, and the eleventh extension segment 672 may also be referred to as a fourth arc line segment. For example, a shape of the eleventh extension segment 672 may match a local shape of the inner edge of the second light shielding region C32. An orthographic projection of tenth extension segment 671 on the third substrate may be overlapped with orthographic projections of the first group of second gate connection lines on the third substrate, an orthographic projection of twelfth extension segment 673 on the third substrate may be overlapped with orthographic projections of the second group of second gate connection lines on the third substrate, and an orthographic projection of eleventh extension segment 672 on the third substrate may be not overlapped with orthographic projections of the plurality of second gate connection lines 68 on the third substrate. The eleventh extension segment 672 may be located on a side of the plurality of second gate connection lines 68 close to the second light transmitting region C31. For example, the tenth extension segment 671, the eleventh extension segment 672, and the twelfth extension segment 673 of the second data connection line 67 may be of a sequentially connected integral structure, and may be located in the fourth conductive layer of the third base substrate, for example. The second data connection line 67 and a second data line 65 to which the second data connection line 67 is connected may be of an interconnected integral structure.

In some examples, as shown in FIG. 19A, a second gate line 66 may be a broken line extending along the first direction X, for example, may be jagged wiring. The second gate line 66 may have a protrusion portion and a recess portion. As shown in FIG. 19B, when a connection position of a second gate connection line 68 and a second gate line 66 is adjacent to a protrusion portion of an adjacent second gate line, the second gate connection line 68 may adopt a turned line design to increase a distance from the protrusion portion of the adjacent second gate line to prevent electrostatic discharge (ESD) from shorting in adjacent wiring or prevent the second gate connection line itself from being disconnected.

In some examples, as shown in FIG. 19B, at least one second gate connection line 68 may have a first turning line segment 685 (as shown in a dashed box in FIG. 19B). A length of the first turning line segment 685 may be less than a length of a first gate line corresponding to one sub-dimming region. For example, at least one second gate connection line 68 bypassing the second light transmitting region from a lower side of the second light transmitting region may have a first turning line segment 685. FIG. 19B shows a second gate connection line 68 farthest from the second light transmitting region among the plurality of second gate connection lines that bypass the second light transmitting region from the lower side of the second light transmitting region. As shown in connection with FIGS. 17 and 19B, the second gate connection line 68 may include a first wiring segment 684 and two first turning line segments 685. One end of a first wiring segment 684 is connected with a first turning line segment 685, and the first turning line segment 685 is connected with a second gate line 66 on a left side of the second light transmitting region; the other end of the first wiring segment 684 is connected with another first turning line segment 685, and the another first turning line segment 685 is connected to a second gate line 66 on a right side of the second light transmitting region. For example, a first wiring segment 684 of a second gate connection line 68 may include the aforementioned seventh extension segment 681, eighth extension segment 682, and ninth extension segment 683 which are sequentially connected. In some examples, a plurality of second gate connection lines 68 that bypass the second light transmitting region from the lower side of the second light transmitting region may each have a first turning line segment. The present embodiment is not limited thereto.

In some examples, as shown in FIG. 19B, the first turning line segment 685 may be a broken line segment extending along the first direction X, and the first turning line segment 685 may be bent along a side away from the second light transmitting region in the second direction Y. For example, a first turning line segment 685 may include a first line segment 6851 and a second line segment 6852. One end of the first line segment 6851 is connected to the first wiring segment 684, the other end is connected to one end of the second line segment 6852, and the other end of the second line segment 6852 is connected to a second gate line 66. A connection point of the first line segment 6851 and the second line segment 6852 may form a first bump 6850. The first line segment 6851 may be substantially a straight line extending toward a side away from the second light transmitting region along a third direction, wherein the third direction may intersect both the first direction and the second direction, and the second line segment 6852 may be substantially a straight line extending along the first direction X. The second line segment 6852 may be located on a side of the first line segment 6851 away from the second light transmitting region. For example, the first bump 6850 may be located on a side of the first wiring segment 684 away from the second light transmitting region. The present embodiment is not limited thereto. In other examples, the first wiring segment may be an arc line segment extending along the first direction X, and the arc line segment may have a first bump located on a side of the first wiring segment away from the second light transmitting region.

FIG. 20 is a planar schematic partial diagram of a second black matrix according to at least one embodiment of the present disclosure. In some examples, as shown in FIG. 20, the second black matrix 623 of the fourth base substrate may include a plurality of first shielding portions 6233 extending along the first direction X in the dimming region. A first shielding portion 6233 may include a plurality of first shielding blocks 62331, a plurality of second shielding blocks 62332, and shielding strips 62333 connected with the first shielding blocks 62331 and the second shielding blocks 62332. A shielding strip 62333 may be connected between adjacent first shielding blocks 62331, and may also connect a first shielding block 62331 and a second shielding block 62332. Orthographic projections of the first shielding blocks 62331 on the third substrate may cover orthographic projections of the light adjustment portions of the second gate lines on the third substrate, orthographic projections of the second shielding blocks 62332 on the third substrate may cover orthographic projections of the gate electrodes of the second thin film transistors on the third substrate, and orthographic projections of the shielding strips 62333 on the third substrate may cover orthographic projections of the connection portions of the second gate lines on the third substrate. For example, a first shielding portion 6233 may be in a shape of a jagged strip structure extending along the first direction X. The plurality of first shielding portions 6233 are sequentially arranged along the second direction Y. Shapes of the first shielding portions 6233 may match shapes of the second gate lines. The plurality of first shielding portions 6233 may shield the plurality of second gate lines and the plurality of second thin film transistors in the dimming region. A disposing mode of the second black matrix of the dimming region of the present example can maximize the openings, thereby ensuring the dimming effect.

In some examples, as shown in FIG. 20, the second black matrix 623 of the fourth base substrate may have a first edge and a second edge in the second light shielding region C32. The first edge of the second black matrix 623 may be in alignment with the inner edge C32a of the second light shielding region C32, and the first edge may have substantially a same shape as the inner edge C32a of the second light shielding region C32, for example, may be an arc-shaped edge. The second edge of the second black matrix 623 may be located on a side of the outer edge C32b of the second light shielding region C32 close to the inner edge C32a, and the second edge may be substantially in a jagged shape to match edge shapes of a portion of dimming units located in the second light shielding region. The second edge of the second black matrix in the second light shielding region does not exceed the outer edge of the second light shielding region, thereby ensuring normal display of the dimming region, and ensuring that the dimming region can perform normal dimming of the backlight.

In some examples, as shown in FIG. 20, the second edge of the second black matrix 623 in the second light shielding region C32 may have first edge portions 6231 extending along the first direction X and second edge portions 6232 extending along the second direction Y. The first edge portions 6231 and the second edge portions 6232 are sequentially connected to form the second edge. A first edge portion 6231 may in a shape of a broken line extending in the first direction X, and the shape of the first edge portion 6231 may match an edge shape of a second gate line extending along the first direction X. A first edge portion 6231 may be connected with a first shielding portion 6233 in the dimming region to form an integrated structure to realize continuous shielding of a second gate line. A second edge portion 6232 may be in a shape of a broken line or a straight line extending in the second direction Y. The second edge portion 6232 may connect two adjacent first edge portions 6231. The edge shape of the second black matrix 623 of the present example can ensure not only normal display of the dimming region, but also normal dimming of the backlight by the dimming region.

In some examples, an orthographic projection of the second black matrix 623 in the second light shielding region C32 may cover the orthographic projections of the plurality of second gate connection lines and the plurality of second data connection lines, so as to prevent the wiring of the second light shielding region from affecting the dimming effect of the dimming region.

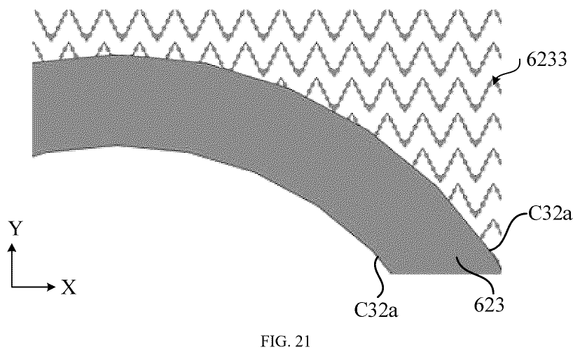

FIG. 21 is another planar schematic partial diagram of a second black matrix according to at least one embodiment of the present disclosure. In some examples, as shown in FIG. 21, the second black matrix 623 of the fourth base substrate may cover the second light shielding region. The first edge of the second black matrix 623 in the second light shielding region may be in alignment with the inner edge C32a of the second light shielding region, and the second edge of the second black matrix 623 in the second light shielding region may be in alignment with the outer edge C32b of the second light shielding region. The second edge may be connected with the plurality of first shielding portions 6233 in the dimming region. The second edge of the second black matrix 623 in the second light shielding region does not exceed the outer edge C32b of the second light shielding region, and the second black matrix 623 may completely shield the second light shielding region, thereby ensuring the normal display of the dimming region and ensuring that the normal dimming of the light incident from the backlight module by the dimming region. Rest of description of the second black matrix of the present example may be referred to description of the aforementioned embodiments, which will not be described here in detail.

The viewing angle control panel of the present example dims the backlight generated by the backlight module, but does not display, thus there is no need to consider jagged feeling of display of the edge of the second light shielding region. Therefore, there is no need to perform gray scale optimization treatment on a boundary region between the second light shielding region and the dimming region.

The viewing angle control panel provided in the present embodiment can realize the anti-peeping function; by disposing the second hole region in the viewing angle control panel and disposing the second hole region in alignment with the first hole region of the display panel, it is possible to help the display apparatus compatibly realize the under-screen camera function, thereby improving the user experience.

The drawings of the present disclosure only involve structures involved in the present disclosure, and other structures may refer to conventional designs. The embodiments of the present disclosure, i.e., features in the embodiments, may be combined with each other to obtain new embodiments if there is no conflict. Those ordinary skilled in the art should understand that modifications or equivalent replacements may be made to the technical solutions of the present disclosure without departing from the essence and scope of the technical solutions of the present disclosure, and shall all fall within the scope of the claims of the present disclosure.

1. A viewing angle control panel comprising: a second hole region and a dimming region located on at least one side of the second hole region; wherein:
in a direction perpendicular to the viewing angle control panel, the viewing angle control panel comprises: a third base substrate, a fourth base substrate, and a second liquid crystal layer disposed between the third base substrate and the fourth base substrate;
the third base substrate comprises a third substrate, a plurality of second thin film transistors, a plurality of second gate lines extending along a first direction, and a plurality of second data lines extending along a second direction; wherein the plurality of second thin film transistors, the plurality of second gate lines, and the plurality of second data lines are located on the third substrate; and the first direction intersects the second direction;
two adjacent second gate lines and two adjacent second data lines define a sub-dimming region, and at least one sub-dimming region is provided with a second thin film transistor; and
the second thin film transistor is configured to control deflection directions of liquid crystal molecules of the second liquid crystal layer located in a corresponding sub-dimming region, so that light incident into the sub-dimming region is emitted in a transmission state or scattering state.

2. The viewing angle control panel according to claim 1, wherein the second hole region of the viewing angle control panel comprises: a second light transmitting region and a second light shielding region surrounding the second light transmitting region;
the fourth base substrate comprises: a fourth substrate and a second black matrix disposed on the fourth substrate; and
the second black matrix has a first edge and a second edge in the second light shielding region; the second light shielding region has an inner edge and an outer edge; the first edge of the second black matrix is flush with the inner edge of the second light shielding region; and the second edge of the second black matrix is flush with the outer edge of the second light shielding region, or the second edge of the second black matrix is located on a side of the outer edge of the second light shielding region close to the inner edge.

3. The viewing angle control panel according to claim 2, wherein the second black matrix comprises a plurality of first shielding portions located in the dimming region extending along the first direction; and orthographic projections of the first shielding portions on the third substrate cover orthographic projections of the second gate lines and the second thin film transistors on the third substrate.

4. The viewing angle control panel according to claim 3, wherein the second edge of the second black matrix in the second light shielding region has first edge portions extending along the first direction and second edge portions extending along the second direction, a shape of a first edge portion matches a shape of a second gate line extending along the first direction, and the first edge portion is connected with a first shielding portion of the dimming region; and
a second edge portion has a shape of a straight line or a broken line extending along the second direction, and the second edge portion connects adjacent first edge portions.

5. The viewing angle control panel according to claim 2, wherein the third base substrate further comprises a plurality of second gate connection lines and a plurality of second data connection lines, the plurality of second gate connection lines and the plurality of second data connection lines are disposed on the third substrate and located in the second light shielding region; and
the second gate connection lines are configured to connect second gate lines separated by the second hole region, and the second data connection lines are configured to connect second data lines separated by the second hole region.

6. The viewing angle control panel according to claim 5, wherein at least one of the second data connection lines comprises a fourth arc line segment, and the fourth arc line segment is located on a side of the plurality of second gate connection lines close to the second light transmitting region.

7. The viewing angle control panel according to claim 5, wherein an orthographic projection of the second black matrix on the third substrate at least partially covers orthographic projections of the plurality of second gate lines, the plurality of second gate connection lines, and the plurality of second data connection lines on the third substrate.

8. The viewing angle control panel according to claim 5, wherein at least one second gate connection line of the plurality of second gate connection lines has a first wiring segment and a first turning line segment, and the first wiring segment is electrically connected with a second gate line through the first turning line segment; and
the first turning line segment has a first bump, and the first bump is located on a side of the first wiring segment away from the second light transmitting region.

9. A display apparatus comprising: a display panel and the viewing angle control panel according to claim 1; wherein:
the display panel comprises a first hole region and a display region located on at least one side of the first hole region; and
the viewing angle control panel is configured to adjust a light emission state of the dimming region according to a display mode of the display panel; and the second hole region of the viewing angle control panel is disposed in alignment with the first hole region of the display panel.

10. The display apparatus according to claim 9, wherein center positions of the second hole region and the first hole region coincide.

11. The display apparatus according to claim 9, wherein the display apparatus further comprises a backlight module, wherein the viewing angle control panel and the display panel are located on a light emission side of the backlight module, and the display panel is located on a side of the viewing angle control panel away from the backlight module; and
the backlight module comprises an camera hole; wherein the camera hole, the first hole region of the display panel and the second hole region of the viewing angle control panel are disposed in alignment.

12. The display apparatus according to claim 11, wherein center positions of the camera hole, the first hole region, and the second hole region coincide.

13. The display apparatus according to claim 11, further comprising a camera assembly located on a side of the backlight module away from the display panel, and the camera assembly comprises a camera, wherein at least a part of the camera is located in a camera hole of the backlight module, a center position of the camera coincides with a center position of the camera hole, and a size of the camera in the first direction is smaller than an aperture of the camera hole.

14. The display apparatus according to claim 11, wherein the second hole region of the viewing angle control panel comprises: a second light transmitting region and a second light shielding region surrounding the second light transmitting region;
the first hole region of the display panel comprises: a first light transmitting region and a first light shielding region surrounding the first light transmitting region;
an orthographic projection of the second light shielding region on the display panel is located in the first light shielding region; and
an orthographic projection of the first light transmitting region on the viewing angle control panel is located in the second light transmitting region.

15. The display apparatus according to claim 14, wherein the first light shielding region has a first outer diameter and a first inner diameter, and the first outer diameter is greater than the first inner diameter;
the second light shielding region has a second outer diameter and a second inner diameter, and the second outer diameter is greater than the second inner diameter, and
the first outer diameter is greater than the second outer diameter, and the first inner diameter is smaller than the second inner diameter.

16. The display apparatus according to claim 15, wherein the first inner diameter is greater than an aperture of the camera hole.

17. The display apparatus according to claim 15, wherein the display panel comprises: a first base substrate, a second base substrate, and a first liquid crystal layer disposed between the first base substrate and the second base substrate;
the first base substrate comprises: a first substrate, a plurality of first control circuits, a plurality of first gate lines, a plurality of first data lines, a plurality of first gate connection lines and a plurality of first data connection lines; the plurality of first control circuits, the plurality of first gate lines, and the plurality of first data lines are disposed on the first substrate and located in the display region; and the plurality of first gate connection lines and the plurality of first data connection lines are disposed on the first substrate and located in the first light shielding region; and
the plurality of first control circuits are electrically connected with the plurality of first gate lines and the plurality of first data lines, the first gate connection lines are configured to connect first gate lines separated by the first hole region, and the first data connection lines are configured to connect first data lines separated by the first hole region.

18. The display apparatus according to claim 17, wherein at least one first data connection line of the plurality of first data connection lines comprises a second arc line segment, and the second arc line segment is located on a side of the plurality of first connection lines close to the first light transmitting region.

19. The display apparatus according to claim 17, wherein the plurality of first data connection lines are alternately arranged in a first conductive layer and a second conductive layer, the second conductive layer is located on a side of the first conductive layer away from the first substrate; and
the plurality of first gate connection lines are located in the first conductive layer.

20. The display apparatus according to claim 17, wherein the second base substrate comprises: a second substrate, a first black matrix and a plurality of filter units; the first black matrix and the plurality of filter units are disposed on the second substrate, the first black matrix has a plurality of first openings, and the plurality of filter units are respectively located in the plurality of first openings;
in a boundary region between the display region and the first light shielding region, sizes of first openings close to the display region are greater than sizes of first openings close to the first light shielding region; and
wherein an orthographic projection of the first black matrix on the first substrate covers orthographic projections of the plurality of first gate connection lines and the plurality of first data connection lines on the first substrate.

21. (canceled)
